(19) United States
(12) Patent Application Publication
(10) Pub. No.: US 2024/0031100 A1
(43) Pub. Date: Jan. 25, 2024

(54) SIDELINK CHANNEL STATE INFORMATION REFERENCE SIGNAL TRIGGERING AND RESOURCE SELECTION

(71) Applicant: QUALCOMM INCORPORATED, San Diego, CA (US)

(72) Inventors: Chenxi Hao, Beijing (CN); Chao Wei, Beijing (CN); Hui Guo, Beijing (CN); Hao Xu, Beijing (CN); Yu Zhang, San Diego, CA (US); Min Huang, Beijing (CN)

(21) Appl. No.: 18/256,267

(22) PCT Filed: Feb. 19, 2021
(86) PCT No.: PCT/CN2021/076862

§ 371 Date: Jun. 7, 2023

(51) Int. Cl. H04L 5/00

(52) U.S. Cl. CPC H04L 5/0051; H04L 5/0057

(57) ABSTRACT

Methods, systems, and devices for wireless communications are described. Techniques are described for a user equipment (UE) to trigger a sidelink channel state information (CSI) procedure without an associated data grant. In some cases, a CSI procedure may be triggered by sending a sequence on a specific resource. In some cases, a CSI procedure may be triggered by a sidelink control information (SCI) message which does not include a sidelink data grant. Techniques are described which avoid CSI reference signal (CSI-RS) resource collision. For example, CSI-RS resources may be selected based on channel sensing, UE identifiers, or a combination thereof. In some cases, UEs may be configured subsets of a CSI-RS resource pool for sending CSI-RS.

### CROSS REFERENCE

The present application is a 371 national stage filing of International PCT Application No. PCT/CN2021/076862 by Hao et al. entitled “SIDELINK CHANNEL STATE INFORMATION REFERENCE SIGNAL TRIGGERING AND RESOURCE SELECTION,” filed Feb. 19, 2021, which is assigned to the assignee hereof, and which is expressly incorporated by reference in its entirety herein.

### FIELD OF TECHNOLOGY

The following relates to wireless communications, including sidelink channel state information reference signal triggering and resource selection.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations or one or more network access nodes, each simultaneously supporting communication for multiple communication devices, which may be otherwise known as user equipment (UE). In some wireless communications systems, a first UE may communicate with a second UE via sidelink communications. Efficient techniques are desired for enabling sidelink communications.

### SUMMARY

The described techniques relate to improved methods, systems, devices, and apparatuses that support sidelink channel state information reference signal triggering and resource selection. Generally, the described techniques provide for triggering a channel state information (CSI) report without providing a data grant. To trigger a CSI request without a corresponding data grant, a first user equipment (UE) may send a signal to a second UE which triggers the CSI report. In some cases, the CSI request may be transmitted in sidelink control information (SCI) with a format that does not include a sidelink data grant. In some cases, the CSI request may be indicated by transmitting a sequence on a specific resource. An index of the sequence and an index of the resource may indicate a request for a CSI measurement to be performed by the first UE and the second UE. For example, each resource index may correspond to a source-destination pair, and each sequence index may correspond to a type of CSI reports. In another example, each resource conveys a destination identifier for the CSI procedure, and a sequence index is used to convey a source identifier and a CSI report type.

Some techniques may be implemented to avoid or prevent CSI reference signal (CSI-RS) resource collisions. A resource pool may be configured with multiple CSI-RS resources or CSI-RS resource sets. A CSI-RS resource or a CSI-RS resource set may be selected based on sensing (e.g., channel sensing), one or more UE identifiers, or a combination thereof. For example, a first UE may have a data transmission for a second UE and may trigger or request a CSI measurement with the second UE on a selected CSI-RS resource set. In some cases, the first UE may perform channel sensing on each CSI-RS resource set in the resource pool and select the CSI-RS resource set for the CSI-RS measurement based on the channel sensing. For example, the first UE may select a CSI-RS resource set with low detected energy to avoid collisions. In some other examples, subsets of the resource pool may be configured for different UEs or for different CSI reports. These techniques may provide a mechanism for selecting a CSI resource set for a CSI measurement while avoiding CSI-RS collisions, such as when the CSI measurement is triggered without a corresponding data grant.

A method for wireless communication at a first user equipment (UE) is described. The method may include transmitting, to a second UE, a trigger message on a sidelink channel to trigger a channel state information (CSI) report, determining, from a set of multiple resource sets within a CSI reference signal (CSI-RS) resource or a resource set pool, a CSI-RS resource set used for CSI measurement based on performing channel sensing or based on a first identifier of the first UE or a second identifier of the second UE, or a CSI report configuration identifier, or any combination thereof, and transmitting or receiving a CSI-RS in the determined CSI-RS resource set.

An apparatus for wireless communication at a first UE is described. The apparatus may include a processor, memory coupled with the processor, and instructions stored in the memory. The instructions may be executable by the processor to cause the apparatus to transmit, to a second UE, a trigger message on a sidelink channel to trigger a CSI report, determine, from a set of multiple resource sets within a CSI reference signal (CSI-RS) resource or a resource set pool, a CSI-RS resource set used for CSI measurement based on performing channel sensing or based on a first identifier of the first UE or a second identifier of the second UE, or a CSI report configuration identifier, or any combination thereof, and transmit or receive a CSI-RS in the determined CSI-RS resource set.

Another apparatus for wireless communication at a first UE is described. The apparatus may include means for transmitting, to a second UE, a trigger message on a sidelink channel to trigger a CSI report, means for determining, from a set of multiple resource sets within a CSI reference signal (CSI-RS) resource or a resource set pool, a CSI-RS resource set used for CSI measurement based on performing channel sensing or based on a first identifier of the first UE or a second identifier of the second UE, or a CSI report configuration identifier, or any combination thereof, and means for transmitting or receiving a CSI-RS in the determined CSI-RS resource set.

A non-transitory computer-readable medium storing code for wireless communication at a first UE is described. The code may include instructions executable by a processor to transmit, to a second UE, a trigger message on a sidelink channel to trigger a CSI report, determine, from a set of multiple resource sets within a CSI reference signal (CSI-RS) resource or a resource set pool, a CSI-RS resource set used for CSI measurement based on performing channel sensing or based on a first identifier of the first UE or a second identifier of the second UE, or a CSI report configuration identifier, or any combination thereof, and transmit or receive a CSI-RS in the determined CSI-RS resource set.

In some examples of the method, apparatuses, and non-transitory computer-readable medium described herein, determining the CSI-RS resource set may include operations, features, means, or instructions for transmitting a signaling to indicate the CSI-RS resource set based on performing channel sensing on the set of multiple resource sets within the CSI-RS resource or the resource set pool.

In some examples of the method, apparatuses, and non-transitory computer-readable medium described herein, determining the CSI-RS resource set may include operations, features, means, or instructions for determining the CSI-RS resource set based on ID of first UE, ID of the second UE or both.

In some examples of the method, apparatuses, and non-transitory computer-readable medium described herein, determining the CSI-RS resource set may include operations, features, means, or instructions for determining a subset of CSI-RS resource sets from the resource set pool and transmitting a signaling to indicate the CSI-RS resource set based on performing channel sensing on the set of multiple resource sets within the subset.

Some examples of the method, apparatuses, and non-transitory computer-readable medium described herein may further include operations, features, means, or instructions for determining the subset of CSI-RS resource sets from the resource set pool based on one or more of the first identifier of the first UE or the second identifier of the second UE, or both, a resource configuration or resource set configuration exchanged with the second UE via sidelink Radio Resource Control signaling, or an association between the CSI report and the subset of the set of multiple resource sets.

In some examples of the method, apparatuses, and non-transitory computer-readable medium described herein, transmitting the trigger message may include operations, features, means, or instructions for determining an association between a set of multiple CSI report configurations and the set of multiple resource sets and determining, based on the association, the CSI-RS resource set according to a CSI report configuration for the triggered CSI report.

Some examples of the method, apparatuses, and non-transitory computer-readable medium described herein may further include operations, features, means, or instructions for transmitting, to the second UE via sidelink Radio Resource Control (RRC) signaling, an indication of the association between the CSI-RS resource set and the CSI report configuration, used by first UE.

Some examples of the method, apparatuses, and non-transitory computer-readable medium described herein may further include operations, features, means, or instructions for receiving, from the second UE via sidelink Radio Resource Control (RRC) signaling, an indication of the association between the CSI-RS resource set and the CSI report configuration, used by the second UE.

Some examples of the method, apparatuses, and non-transitory computer-readable medium described herein may further include operations, features, means, or instructions for exchanging, with the second UE via sidelink Radio Resource Control (RRC) signaling, a first configuration for a first subset of the set of multiple resource sets configured for the first UE and a second configuration for second subset of the set of multiple resource sets configured for the second UE.

Some examples of the method, apparatuses, and non-transitory computer-readable medium described herein may further include operations, features, means, or instructions for generating a sequence for a CSI-RS based on the first identifier for the first UE, the second identifier for the second UE, or both.

Some examples of the method, apparatuses, and non-transitory computer-readable medium described herein may further include operations, features, means, or instructions for receiving, from a network entity, a configuration of the resource set pool associated with CSI-RS measurement, the resource set pool including the set of multiple resource sets.

In some examples of the method, apparatuses, and non-transitory computer-readable medium described herein, a frequency domain allocation for the CSI-RS resource set spans a total resource pool associated with the sidelink channel.

Some examples of the method, apparatuses, and non-transitory computer-readable medium described herein may further include operations, features, means, or instructions for transmitting, via sidelink control information or sidelink Radio Resource Control (RRC), an indication that a frequency domain allocation for the CSI-RS resource set spans a subset of subchannels of a resource pool associated with the sidelink channel.

Some examples of the method, apparatuses, and non-transitory computer-readable medium described herein may further include operations, features, means, or instructions for transmitting, via sidelink control information, an indication of a time domain allocation for the CSI-RS resource set.

A method for wireless communication at a first UE is described. The method may include generating a signal to trigger a CSI report configuration for a sidelink channel and transmitting, to a second UE, the signal on the sidelink channel to trigger the CSI report configuration for the sidelink channel, where the signal excludes a grant for data transmission, and transmitting or receiving a CSI-RS based on the CSI report configuration.

An apparatus for wireless communication at a first UE is described. The apparatus may include a processor, memory coupled with the processor, and instructions stored in the memory. The instructions may be executable by the processor to cause the apparatus to generate a signal to trigger a CSI report configuration for a sidelink channel, transmit, to a second UE, the signal on the sidelink channel to trigger the CSI report configuration for the sidelink channel, where the signal excludes a grant for data transmission, and transmit or receive a CSI-RS based on the CSI report configuration.

Another apparatus for wireless communication at a first UE is described. The apparatus may include means for generating a signal to trigger a CSI report configuration for a sidelink channel, means for transmitting, to a second UE, the signal on the sidelink channel to trigger the CSI report configuration for the sidelink channel, where the signal excludes a grant for data transmission, and means for transmitting or receiving a CSI-RS based on the CSI report configuration.

A non-transitory computer-readable medium storing code for wireless communication at a first UE is described. The code may include instructions executable by a processor to generate a signal to trigger a CSI report configuration for a sidelink channel, transmit, to a second UE, the signal on the sidelink channel to trigger the CSI report configuration for the sidelink channel, where the signal excludes a grant for data transmission, and transmit or receive a CSI-RS based on the CSI report configuration.

In some examples of the method, apparatuses, and non-transitory computer-readable medium described herein, transmitting the signal may include operations, features, means, or instructions for transmitting a sequence from a set of sequences, via a sequence resource determined from a set of sequence resources, where the sequence and the determined sequence resource indicate the first UE, the second UE and the triggered CSI report configuration.

Some examples of the method, apparatuses, and non-transitory computer-readable medium described herein may further include operations, features, means, or instructions for determining the sequence resource based on a source-destination identifier.

Some examples of the method, apparatuses, and non-transitory computer-readable medium described herein may further include operations, features, means, or instructions for determining the sequence based on one or more of the triggered CSI report configuration and a CSI reference signal (CSI-RS) resource configuration.

Some examples of the method, apparatuses, and non-transitory computer-readable medium described herein may further include operations, features, means, or instructions for determining the sequence resource based on a destination identifier for the CSI report configuration.

Some examples of the method, apparatuses, and non-transitory computer-readable medium described herein may further include operations, features, means, or instructions for determining the sequence based on a source identifier and one or more of the triggered CSI report configuration and a CSI reference signal (CSI-RS) resource configuration.

In some examples of the method, apparatuses, and non-transitory computer-readable medium described herein, transmitting the signal may include operations, features, means, or instructions for transmitting the signal in the sequence resource selected from a set of multiple available sequence resources, where the set of multiple available sequence resources may be configured at the first UE via system information, Radio Resource Control (RRC) signaling from a base station, or sidelink radio resource control (RRC) signaling with the second UE.

In some examples of the method, apparatuses, and non-transitory computer-readable medium described herein, transmitting the signal may include operations, features, means, or instructions for transmitting a sidelink control information (SCI) message including a CSI request excluding the grant for data transmission.

In some examples of the method, apparatuses, and non-transitory computer-readable medium described herein, the SCI message may have a first format of a first-stage SCI message without data, may have a second format of the first-stage SCI message, or may be a second-stage SCI message.

Some examples of the method, apparatuses, and non-transitory computer-readable medium described herein may further include operations, features, means, or instructions for scrambling a cyclic redundancy check (CRC) of the SCI message based on the SCI message having the first format of the first-stage SCI message.

In some examples of the method, apparatuses, and non-transitory computer-readable medium described herein, the SCI message includes one or more of a time domain resource allocation field of a CSI reference signal (CSI-RS), a frequency domain resource allocation field of the CSI-RS, and a physical sidelink feedback channel (PSFCH) resource indicator.

In some examples of the method, apparatuses, and non-transitory computer-readable medium described herein, a physical sidelink feedback channel (PSFCH) for reporting a CSI-RS measurement may be a long PSFCH spanning multiple symbol periods, the PSFCH may be indicated in a sidelink control information (SCI) message to trigger the CSI report configuration, or the PSFCH may be indicated based at last in part on one or more of a sequence resource, a sequence transmitted on the sequence resource, and a slot index of the sequence resource, or the PSFCH may be indicated based at last in part on one or more of a source-destination identifier, a triggered CSI report identifier, and a slot index of a sequence transmission occasion.

Some examples of the method, apparatuses, and non-transitory computer-readable medium described herein may further include operations, features, means, or instructions for determining a set of resources within a selection window based on a spectral efficiency or a channel quality indicator (CQI) for the set of candidate CSI-RS resources satisfying a first spectral efficiency threshold or a first channel quality information (CQI) threshold.

Some examples of the method, apparatuses, and non-transitory computer-readable medium described herein may further include operations, features, means, or instructions for determining a proportion of the set of resources does not satisfy a threshold, determining a second spectral efficiency threshold which may be lower than the first spectral efficiency threshold, or a second CQI threshold which may be lower than the first CQI threshold, or any combination thereof, and determining a second set of candidate resources based on the second spectral efficiency threshold or the second CQI threshold.

A method for wireless communication at a second UE is described. The method may include receiving, from a first UE, a trigger message on a sidelink channel to trigger a CSI report, determining, from a set of multiple resource sets within a CSI reference signal (CSI-RS) resource or a resource set pool, a CSI-RS resource set used for CSI measurement based on channel sensing or based on a first identifier of the first UE, or a second identifier of the second UE, or a CSI report configuration identifier, or any combination thereof, and transmitting or receiving a CSI-RS in the determined CSI-RS resource set.

An apparatus for wireless communication at a second UE is described. The apparatus may include a processor, memory coupled with the processor, and instructions stored in the memory. The instructions may be executable by the processor to cause the apparatus to receive, from a first UE, a trigger message on a sidelink channel to trigger a CSI report, determine, from a set of multiple resource sets within a CSI reference signal (CSI-RS) resource or a resource set pool, a CSI-RS resource set used for CSI measurement based on channel sensing or based on a first identifier of the first UE, or a second identifier of the second UE, or a CSI report configuration identifier, or any combination thereof, and transmit or receive a CSI-RS in the determined CSI-RS resource set.

Another apparatus for wireless communication at a second UE is described. The apparatus may include means for receiving, from a first UE, a trigger message on a sidelink channel to trigger a CSI report, means for determining, from a set of multiple resource sets within a CSI reference signal (CSI-RS) resource or a resource set pool, a CSI-RS resource set used for CSI measurement based on channel sensing or based on a first identifier of the first UE, or a second identifier of the second UE, or a CSI report configuration identifier, or any combination thereof, and means for transmitting or receiving a CSI-RS in the determined CSI-RS resource set.

A non-transitory computer-readable medium storing code for wireless communication at a second UE is described. The code may include instructions executable by a processor to receive, from a first UE, a trigger message on a sidelink channel to trigger a CSI report, determine, from a set of multiple resource sets within a CSI reference signal (CSI-RS) resource or a resource set pool, a CSI-RS resource set used for CSI measurement based on channel sensing or based on a first identifier of the first UE, or a second identifier of the second UE, or a CSI report configuration identifier, or any combination thereof, and transmit or receive a CSI-RS in the determined CSI-RS resource set.

A method for wireless communication at a second UE is described. The method may include receiving, from a first UE, a signal on a sidelink channel to trigger a CSI report configuration for the sidelink channel, where the signal excludes a grant for data transmission, determining a destination identifier for a CSI measurement and a source identifier for the CSI measurement based on the signal, and transmitting or receiving a CSI-RS based on the CSI report configuration.

An apparatus for wireless communication at a second UE is described. The apparatus may include a processor, memory coupled with the processor, and instructions stored in the memory. The instructions may be executable by the processor to cause the apparatus to receive, from a first UE, a signal on a sidelink channel to trigger a CSI report configuration for the sidelink channel, where the signal excludes a grant for data transmission, determine a destination identifier for a CSI measurement and a source identifier for the CSI measurement based on the signal, and transmit or receive a CSI-RS based on the CSI report configuration.

Another apparatus for wireless communication at a second UE is described. The apparatus may include means for receiving, from a first UE, a signal on a sidelink channel to trigger a CSI report configuration for the sidelink channel, where the signal excludes a grant for data transmission, means for determining a destination identifier for a CSI measurement and a source identifier for the CSI measurement based on the signal, and means for transmitting or receiving a CSI-RS based on the CSI report configuration.

A non-transitory computer-readable medium storing code for wireless communication at a second UE is described. The code may include instructions executable by a processor to receive, from a first UE, a signal on a sidelink channel to trigger a CSI report configuration for the sidelink channel, where the signal excludes a grant for data transmission, determine a destination identifier for a CSI measurement and a source identifier for the CSI measurement based on the signal, and transmit or receive a CSI-RS based on the CSI report configuration.

### BRIEF DESCRIPTION OF THE DRAWINGS

FIG. 1 illustrates an example of a wireless communications system that supports sidelink channel state information (CSI) reference signal (CSI-RS) triggering and resource selection in accordance with aspects of the present disclosure.

FIG. 2 illustrates an example of a wireless communications system that supports sidelink CSI-RS triggering and resource selection in accordance with aspects of the present disclosure.

FIGS. 5A and 3B illustrate examples of resource reservations that support sidelink CSI-RS triggering and resource selection in accordance with aspects of the present disclosure.

FIG. 6 illustrates an example of a CSI-RS configuration that supports sidelink CSI-RS triggering and resource selection in accordance with aspects of the present disclosure.

FIGS. 7 through 10 illustrate examples of process flows that support sidelink CSI-RS triggering and resource selection in accordance with aspects of the present disclosure.

FIG. 11 illustrates examples of CSI-RS frequency resource allocation schemes that support sidelink CSI-RS triggering and resource selection in accordance with aspects of the present disclosure.

FIG. 12 illustrates examples of CSI-RS time resource allocation schemes that support sidelink CSI-RS triggering and resource selection in accordance with aspects of the present disclosure.

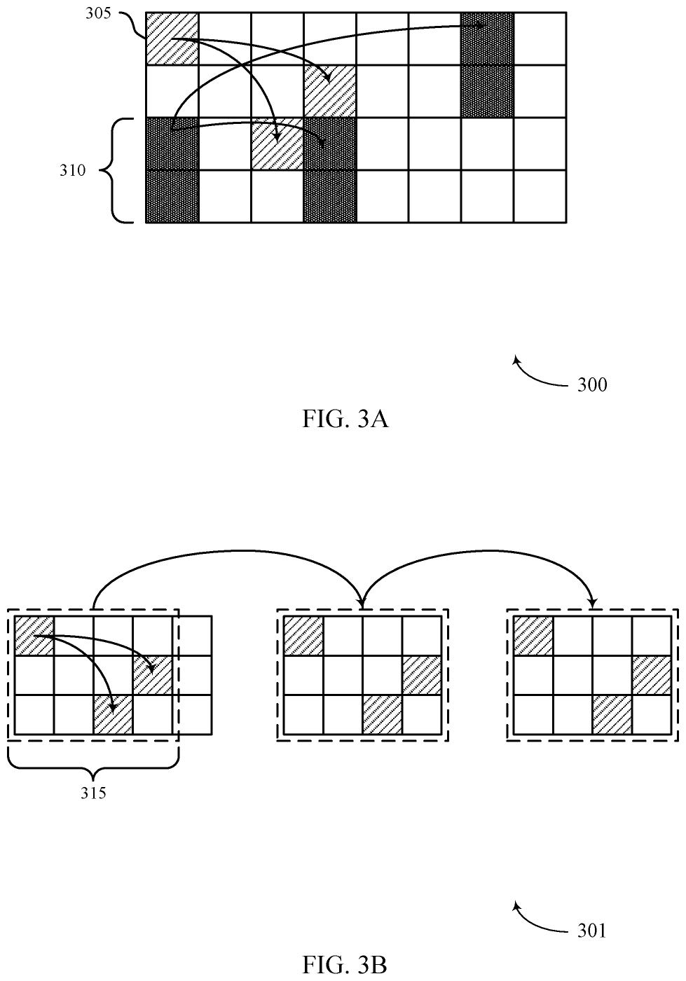

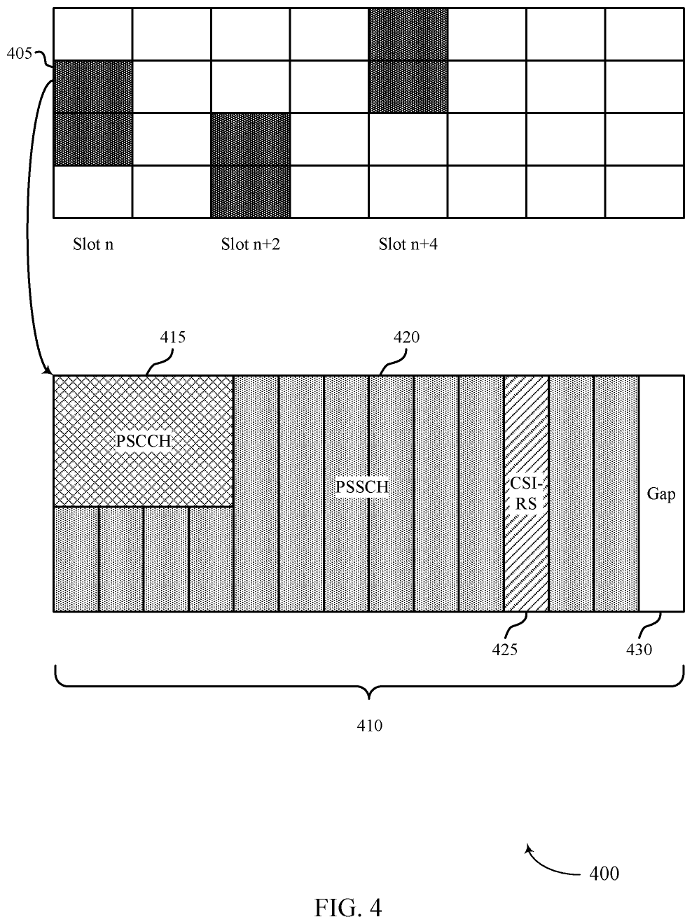

FIG. 3 illustrate an example of a CSI triggering sequence resource configuration that supports sidelink CSI-RS triggering and resource selection in accordance with aspects of the present disclosure.

FIG. 4 illustrates an example of CSI triggering sequence configurations that supports sidelink CSI-RS triggering and resource selection in accordance with aspects of the present disclosure.

FIGS. 13 and 14 show block diagrams of devices that support sidelink CSI-RS triggering and resource selection in accordance with aspects of the present disclosure.

FIG. 15 shows a block diagram of a communications manager that supports sidelink CSI-RS triggering and resource selection in accordance with aspects of the present disclosure.

FIG. 16 shows a diagram of a system including a device that supports sidelink CSI-RS triggering and resource selection in accordance with aspects of the present disclosure.

FIGS. 17 through 20 show flowcharts illustrating methods that support sidelink CSI-RS triggering and resource selection in accordance with aspects of the present disclosure.

### DETAILED DESCRIPTION

For sidelink communications between two user equipments (UEs), the two UEs may perform a channel state information (CSI) reporting procedure to determine a desired configuration to enhance sidelink communications. For example, a first UE may transmit a CSI request to a second UE in a sidelink control information (SCI) message that schedules a sidelink data transmission. The first UE may then transmit one or more CSI reference signals (CSI-RSs) to the second UE in a same subchannel of a physical sidelink shared channel (PSSCH). The second UE may then measure the CSI-RSs to determine the CSI and transmit a CSI report back to the first UE for the first UE to determine the desired configuration for subsequent transmissions.

However, this CSI procedure may include deficiencies. For example, CSI-RSs may be transmitted on same subchannels as sidelink data transmissions, so reported CSI may not provide CSI for overall subchannels of interest (e.g., the reported CSI may provide CSI for the same subchannels as the sidelink data transmissions alone). Additionally, a CSI-RS report may be transmitted after a sidelink data transmission, and thus, the sidelink data transmission may be transmitted without the benefit of CSI information on the subchannel(s).

The techniques described herein are directed to triggering a CSI report without providing a data grant. These techniques may enable sidelink CSI reporting without scheduling a sidelink data transmission. By decoupling sidelink CSI from sidelink data scheduling, UEs may perform CSI measurement in advance of sidelink data transmission and use the CSI measurement to increase sidelink communications quality. To trigger a CSI request without a corresponding data grant, a first UE may send a signal to a second UE which triggers the CSI report. In some cases, the CSI request may be transmitted in a format of SCI which does not include a sidelink data grant. In some cases, the CSI request may be indicated by transmitting a sequence on a specific resource. An index of the sequence and an index of the resource may indicate a request for a CSI report requested from the first UE to the second UE. In some cases, a CSI report may include reciprocal based techniques where the second UE transmits CSI-RS and the first UE performs CSI measurement or non-reciprocal based techniques where the first UE transmits CSI-RS and the second UE performs CSI measurement and reports the CSI to the first UE, or both. For example, each resource index may correspond to a source-destination pair, and each sequence index may correspond to a particular CSI report configuration or CSI report trigger state which may include one or more CSI report configurations. In another example, each resource conveys a destination identifier for the CSI procedure, and a sequence index is used to convey a source identifier and a particular CSI report or CSI report trigger state which includes one or more CSI reports. In another example, each resource conveys a source identifier for the CSI procedure, and a sequence index is used to convey a destination identifier and a particular CSI report or CSI report trigger state which includes one or more CSI reports.

Some techniques may be implemented to avoid or prevent CSI-RS resource collisions. A CSI-RS resource pool may be configured with multiple CSI-RS resources or CSI-RS resource sets. A CSI-RS resource pool may be a pool of CSI-RS resources, each resource occupying certain resource elements in each resource block and occurring at some symbols of a slot. A CSI-RS resource or a CSI-RS resource set may be selected based on sensing (e.g., channel sensing), one or more UE identifiers, a CSI report configuration identifier, or a combination thereof. For example, a first UE may have a data transmission for a second UE and may trigger or request a CSI measurement with the second UE on a selected CSI-RS resource set. In some cases, the first UE may perform channel sensing on each CSI-RS resource set in the resource pool and select the CSI-RS resource set for the CSI-RS measurement based on the channel sensing. For example, the first UE may select a CSI-RS resource set with low detected energy to avoid collisions. In some other examples, subsets of the resource pool may be configured for different UEs, different CSI reports, or CSI report configurations. These techniques may provide a mechanism for selecting a CSI resource set for a CSI measurement while avoiding CSI-RS collisions, such as when the CSI measurement is triggered without a corresponding data grant.

Aspects of the disclosure are initially described in the context of wireless communications systems. Aspects of the disclosure are further illustrated by and described with reference to apparatus diagrams, system diagrams, and flowcharts that relate to sidelink channel state information reference signal triggering and resource selection.

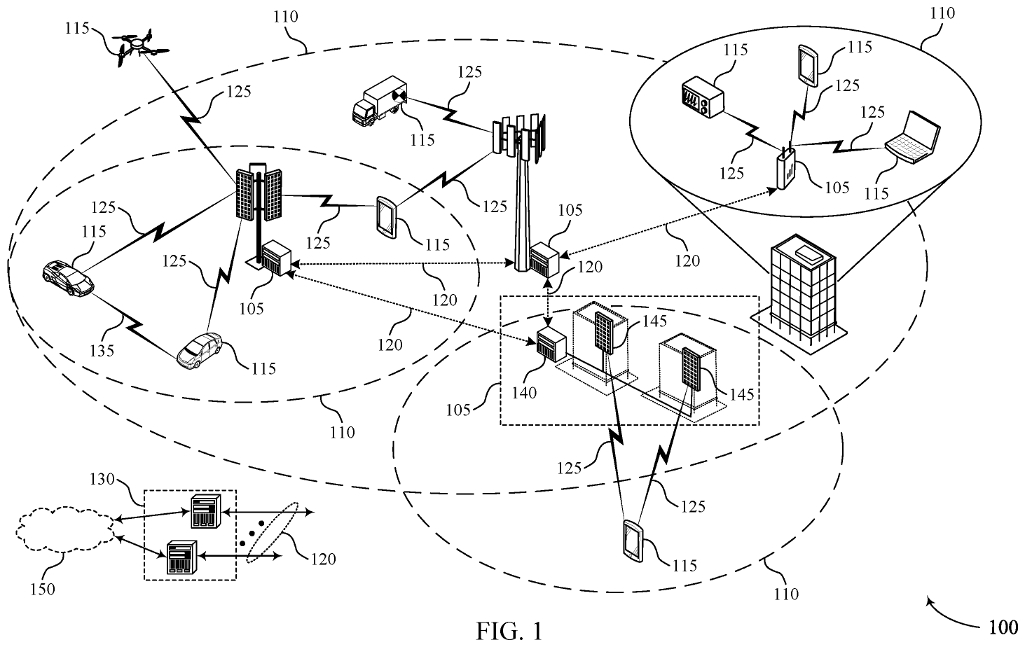

FIG. 1 illustrates an example of a wireless communications system 100 that supports sidelink channel state information reference signal triggering and resource selection in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a CSI-RS), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

The wireless communications system 100 may support techniques to decouple data transmission scheduling and CSI requests. Additionally, the wireless communications system 100 may support techniques to select CSI-RS resources to prevent CSI-RS collision.

In some cases, signaling carrying a trigger for a CSI report may not include a grant for data transmission. By not including a grant for a data transmission with the trigger message, a CSI request may be decoupled from sidelink data transmission scheduling. In some cases, the wireless communications system 100 may support an SCI without a grant of data transmission. Additionally, or alternatively, the wireless communications system may support a sequence-based CSI triggering. For example, the CSI report may be triggered by transmitting a sequence on a certain resource. The wireless communications system 100 may also support techniques to avoid collisions on CSI-RS resources. The wireless communications system 100 may support a CSI-RS resource pool. In some cases, a transmitting UE 115 or a receiving UE 115, or both, may select CSI-RS resources based on sensing or based on UE identifiers, channel sensing, or both.

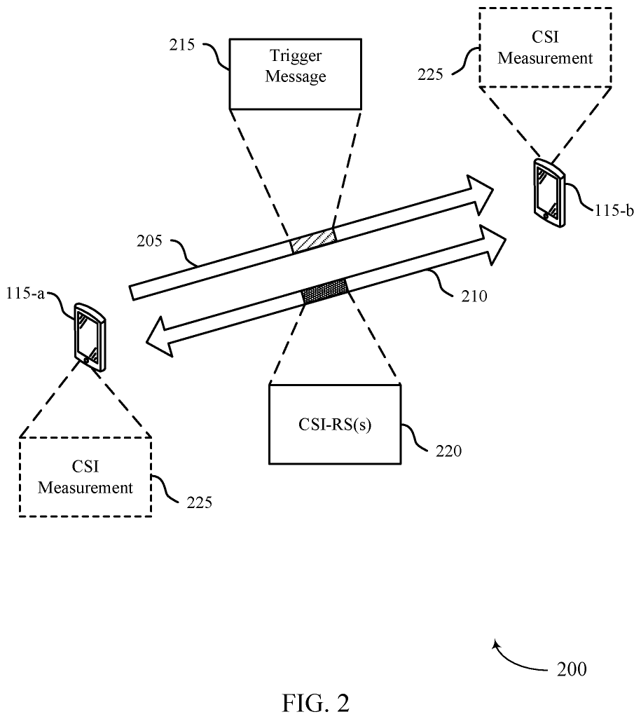

FIG. 2 illustrates an example of a wireless communications system 200 that supports sidelink channel state information reference signal triggering and resource selection in accordance with aspects of the present disclosure. Wireless communications system 200 may implement aspects of or may be implemented by aspects of wireless communications system 100. For example, wireless communications system 200 may include a UE 115-a and a UE 115-b, which may represent examples of UEs 115 as described with reference to FIG. 1. Additionally, UE 115-a and UE 115-b may communicate on resources of a carrier 205 (e.g., for transmitting control information or configuration information) and of a carrier 210 (e.g., for sidelink communications). Although shown as separate carriers, carrier 205 and carrier 210 may include same or different resources (e.g., time and frequency resources) for the corresponding transmissions.

In some cases, as part of sidelink communications between UE 115-a and UE 115-b, UE 115-a may indicate for UE 115-b to perform a CSI reporting or CSI acquisition mode. For example, UE 115-a may transmit a CSI request to UE 115-b in an SCI message that schedules a sidelink data transmission. UE 115-a may then transmit one or more CSI-RSs to UE 115-b in a same subchannel of a PSSCH, such that CSI is reported for subchannels that contain the one or more CSI-RSs. UE 115-b may then measure the CSI-RSs to determine the CSI and transmit a CSI report back to UE 115-a for UE 115-a to determine a desired configuration for subsequent transmissions. However, as described with reference to FIG. 1, using this CSI reporting or CSI acquisition mode, CSI-RSs may be transmitted on same subchannels as sidelink data transmissions, so reported CSI may not provide CSI for overall subchannels of interest (e.g., CSIs on subchannels other than the transmitted sidelink data is not obtained), a CSI report may be transmitted after a sidelink data transmission (e.g., such that the sidelink data transmission may be transmitted without the benefit of CSI information), and reciprocal-based CSI reporting may not be supported. As such, enhancements are desired for an improved CSI reporting or CSI acquisition procedure.

The wireless communications system 200 may support reciprocal based CSI and non-reciprocal based CSI. For example, UE 115-a may transmit a trigger message 215, which may be included with a CSI request, to UE 115-b, which may initiate a reciprocal-based CSI acquisition procedure (e.g., a CSI reporting mode 1). In a reciprocal-based CSI acquisition procedure, a source UE 115, such as UE 115-a, may perform a CSI measurement based on reference signals according to a configuration (e.g., a CSI-RS configuration) or a reporting mode (e.g., a CSI reporting mode) indicated by a trigger and transmitted by a destination UE 115, such as UE 115-b. The reference signals may include one or more CSI-RS, one or more SRS, or another reference signal for measuring channel characteristics. For example, the trigger may indicate to UE 115-b which report or trigger state is triggered. In some cases, the configurations of CSI reports may be provided to the UEs 115 via RRC signaling. Based on receiving the trigger for the reciprocal-based CSI acquisition procedure, UE 115-b may transmit one or more CSI-RSs 220 to UE 115-a.

For the reciprocal-based CSI acquisition procedure, UE 115-a may perform a CSI measurement 225 based on receiving the one or more CSI-RSs 220 from UE 115-b. In some cases, UE 115-a may reserve resources based on the CSI measurement 225 and may transmit a sidelink data transmission to UE 115-b using the reserved resources. Additionally, UE 115-a may determine a configuration or parameters for transmitting the sidelink data transmission based on the CSI measurement.

UE 115-c may transmit one or more CSI report configurations to UE 115-d via RRC, where each CSI report may comprise one or more parameters, such as a report quantity, a time domain type (e.g., periodic, semi-periodic, or aperiodic), a codebook, etc. In some cases, UE 115-c may further transmit a CSI report trigger state configuration to UE 115-d, where each trigger state may include one or more CSI reports. As described in FIG. 2, UE 115-c may transmit a trigger message (e.g., a CSI request) to trigger a CSI report or a CSI trigger state that includes one or more CSI reports. Based on the triggered CSI report or CSI trigger state, UE 115-c and UE 115-d may know whether to transmit or receive a CSI-RS based on a report quantity for the CSI report or the CSI trigger state, where the report quantity implicitly indicates the CSI reporting mode (e.g., reciprocal based or non-reciprocal based). In some implementations, the reporting quantity may implicitly indicate that the triggered CSI acquisition procedure is non-reciprocal-based. For example, the reporting quantity may be set to a different quantity than “antenna switching” (e.g., “subchannel selection,” “RI-CQI reporting,” “RI-PMI-CQI reporting,” “RI-CQI-subchannel-selection,” “RI-PMI-CQI-subchannel-selection,” etc.), where UE 115-d is triggered to monitor for and receive the one or more CSI-RSs at 510-b from UE 115-c based on the reporting quantity being set to a different quantity than “antenna switching.”

For a non-reciprocal-based CSI acquisition procedure, UE 115-a may transmit a trigger message 215 to UE 115-b. However, unlike a reciprocal-based CSI acquisition procedure, the trigger may initiate a non-reciprocal-based CSI acquisition procedure (e.g., a CSI reporting mode 2), where a destination UE 115, such as UE 115-b, performs a CSI measurement 225 and transmits channel state feedback. For example, the trigger message 215 may indicate that UE 115-a will subsequently transmit one or more CSI-RSs 220 according to a CSI configuration or CSI reporting mode indicated by the trigger. Based on transmitting the trigger message 215 for the non-reciprocal-based CSI acquisition procedure, UE 115-a may transmit one or more CSI-RSs 220 to UE 115-b. UE 115-b may perform a CSI measurement 225 based on receiving the one or more CSI-RSs from UE 115-a. UE 115-b may transmit channel state feedback (e.g., on a reserved long physical sidelink feedback channel (PSFCH), or via a MAC-CE transmitted on a PSSCH to be reserved by UE2UE 115-d when the CSI report is ready) to UE 115-a to indicate the CSI measurement (e.g., a CSI report) performed on the one or more CSI-RSs 220. In some examples, UE 115-a may reserve resources based on the CSI measurement and may transmit a sidelink data transmission to UE 115-b using the reserved resources. Additionally, UE 115-a may determine a configuration or parameters for transmitting the sidelink data transmission based on the CSI measurement.

In some cases, UE 115-a may transmit CSI report configurations and trigger state configurations to UE 115-b. The configurations for the trigger state or CSI report configurations may be provided by RRC signaling or pre-configured. A trigger signal, such as the trigger message 215, may indicate which report or trigger state is triggered. In some cases, the trigger message may be a CSI request that triggers a CSI report and the report quantity may be included in each CSI report configuration. For example, UE 115-a may send a CSI request, indicating which report configuration or trigger state is triggered. In some cases, the CSI report configuration includes a reporting quantity (e.g., antenna switching, RI-CQI, subchannel-selection, PMI-based channel measurements, etc.). The trigger message 215 may be a CSI request that includes a trigger for a CSI trigger state, where the CSI trigger state includes one or more CSI report configurations and report quantity may be included in each CSI report configuration. For example, a trigger state indicated by trigger message 215 may include multiple CSI reports (e.g., a CSI report 1, a CSI report 2, etc.), where each CSI report is performed based a corresponding CSI report configuration that includes a respective set of parameters, such as a codebook type, a time domain type (e.g., periodic, semi-persistent, aperiodic), a report quantity, a carrier ID (e.g., which carrier that a CSI measurement is to be performed using), etc. In some cases, UE 115-a or UE 115-b may transmit the CSI-RSs based on the triggered report configuration or trigger state. For example, UE 115-a or UE 115-b may transmit CSI-RS based on a report quantity in the triggered CSI report, and UE 115-a or UE 115-b may perform a CSI measurement according to the configuration of the triggered CSI report.

The wireless communications system 200 may support techniques to decouple data transmission scheduling and CSI requests. Additionally, the wireless communications system 200 may support techniques to select CSI-RS resources to prevent CSI-RS collision.

In some cases, the signaling containing trigger message 215 may not include a grant for data transmission. By not including a grant for a data transmission with the trigger message 215, a CSI request may be decoupled from sidelink data transmission scheduling. In some cases, the wireless communications system 200 may support an SCI without a grant of data transmission. The SCI without a grant of data transmission may, for example, be a new SCI. For example, the trigger message 215 may be an explicit CSI request in the SCI. The SCI may include a destination UE identifier, a source UE identifier, and a CSI request. In some cases, the CSI request may include multiple bits to indicate one or more triggered CSI reports. In some cases, a codepoint of CSI request triggers a CSI report trigger state which includes multiple CSI reports and all the CSI reports in the triggered state are triggered. The SCI may include a CSI-RS resource or resource set indication, which may be used to select an active resource or resource set to measure the CSI. In some cases, the resource or resource set indication may be used jointly with a destination UE identifier to determine a resource or resource set. The SCI may include a frequency domain allocation of the CSI-RS, such as which subchannels are used to transmit the CSI-RS. In some cases, the SCI may include a time domain allocation of the CSI-RS, such as a slot offset of the CSI-RS transmission. In some cases, the triggered CSI report(s) may be transmitted via PSFCH, the SCI may include a PSFCH resource indication. Additionally, or alternatively, the source UE identifier, or destination UE identifier, a triggered CSI report configuration identifier, the associated CSI-RS resource/resource-set, the sequence and sequence resource used for CSI request, or combination of any of them, may be used to determine the PSFCH resource. In some cases, the PSFCH is a long PSFCH spanning multiple symbols. In some cases, the PSFCH resource indication may not be used if the CSI report quantity is set to “antenna switching.”

In some cases, the SCI may be an example of a dedicated first-stage SCI format without data. For example, the SCI to trigger the CSI may be an SCI with SCI format 1-B. In some cases, the SCI may be based on including new fields or repurposing fields in an existing SCI format. For example, new fields (e.g., CSI-RS resource/resource-set indication, FDRA, TDRA of the CSI-RS resource/resource-set, and PSFCH indication) may be added for SCI format 1-A. In some cases, CRC scrambling may be used to determine that the additional fields are valid and other fields are not used. In some cases, the SCI may be a second-stage SCI with a dedicated second-stage SCI format.

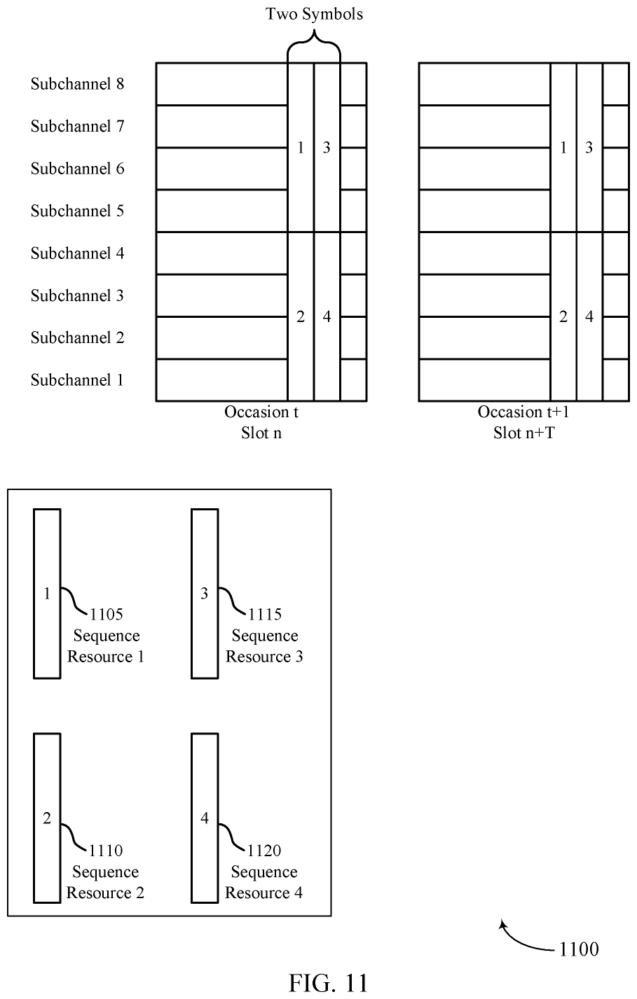

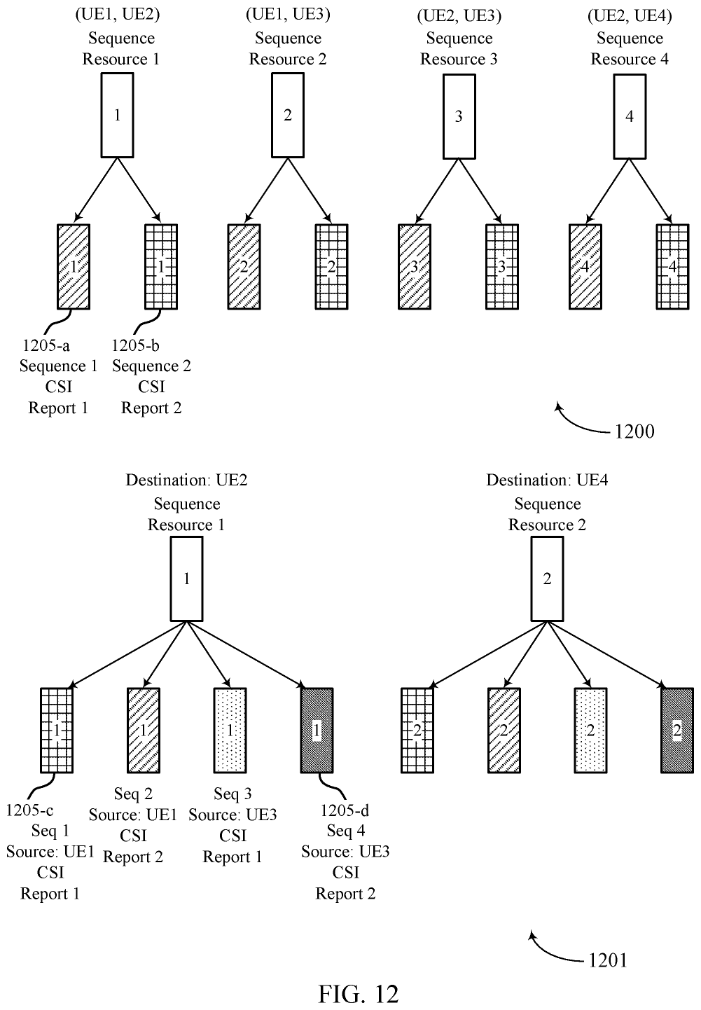

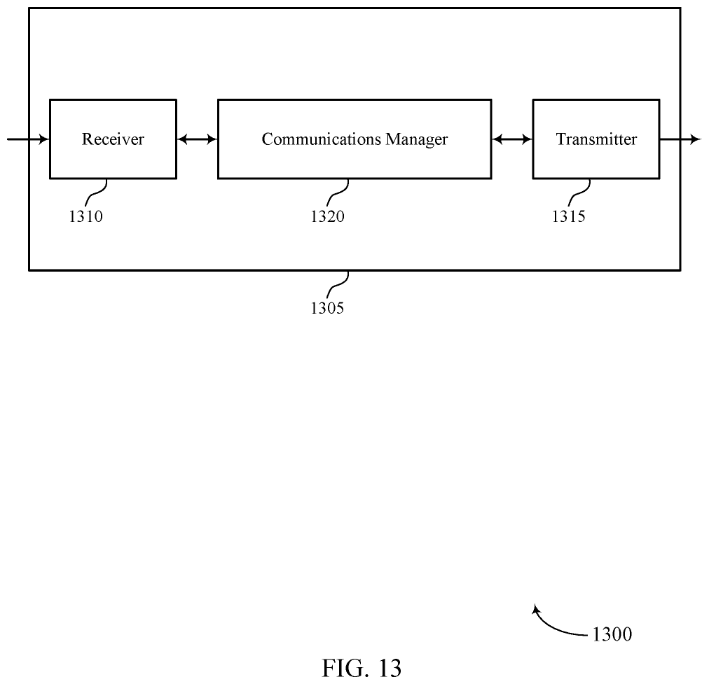

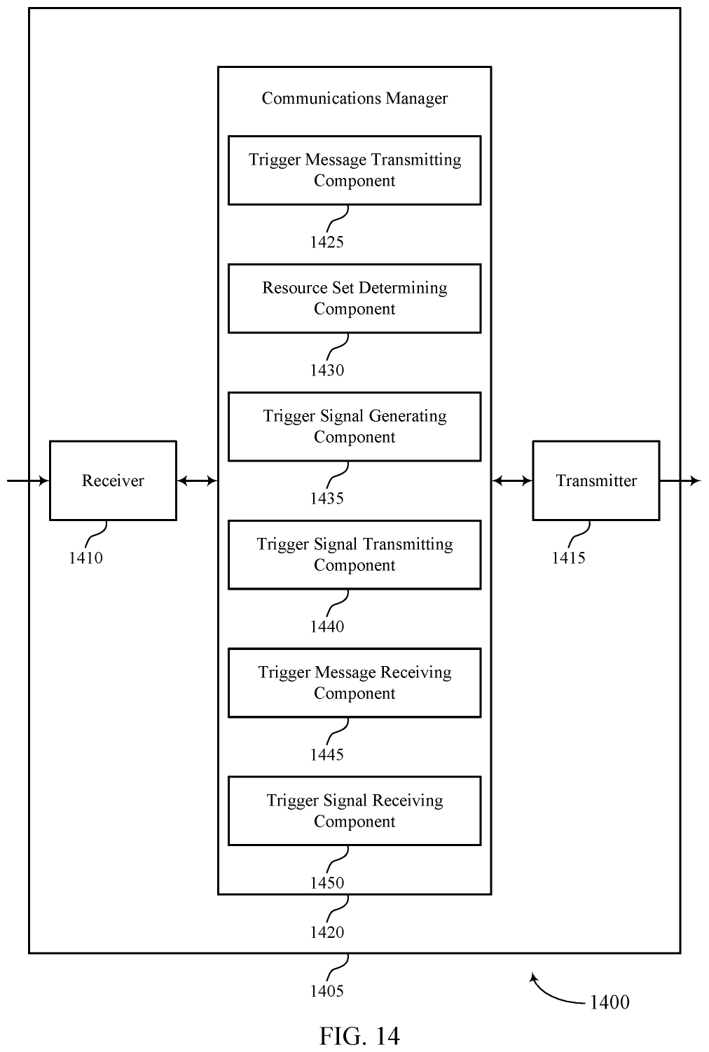

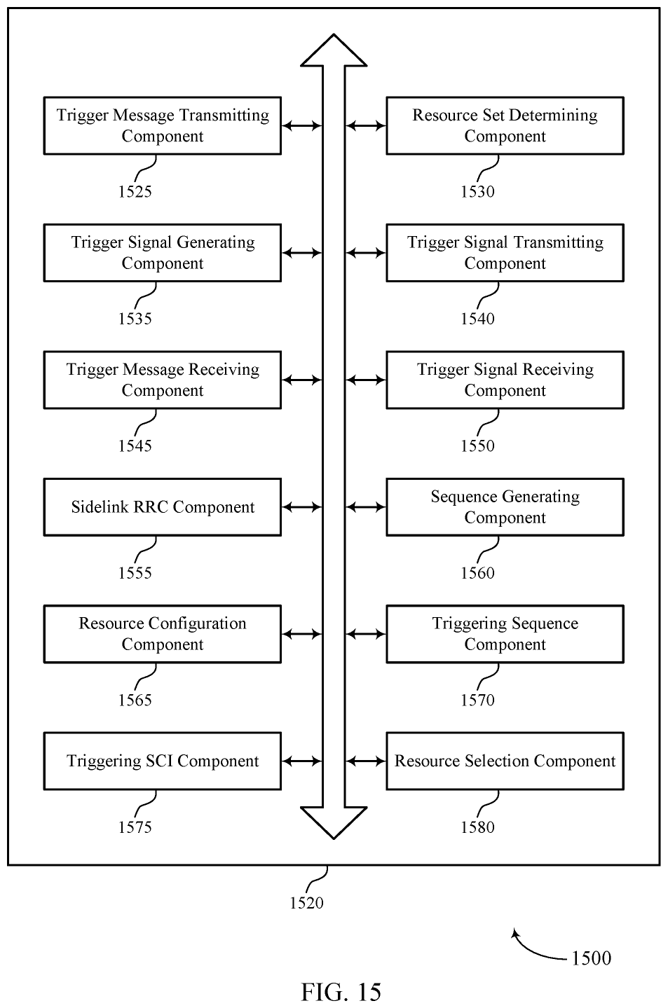

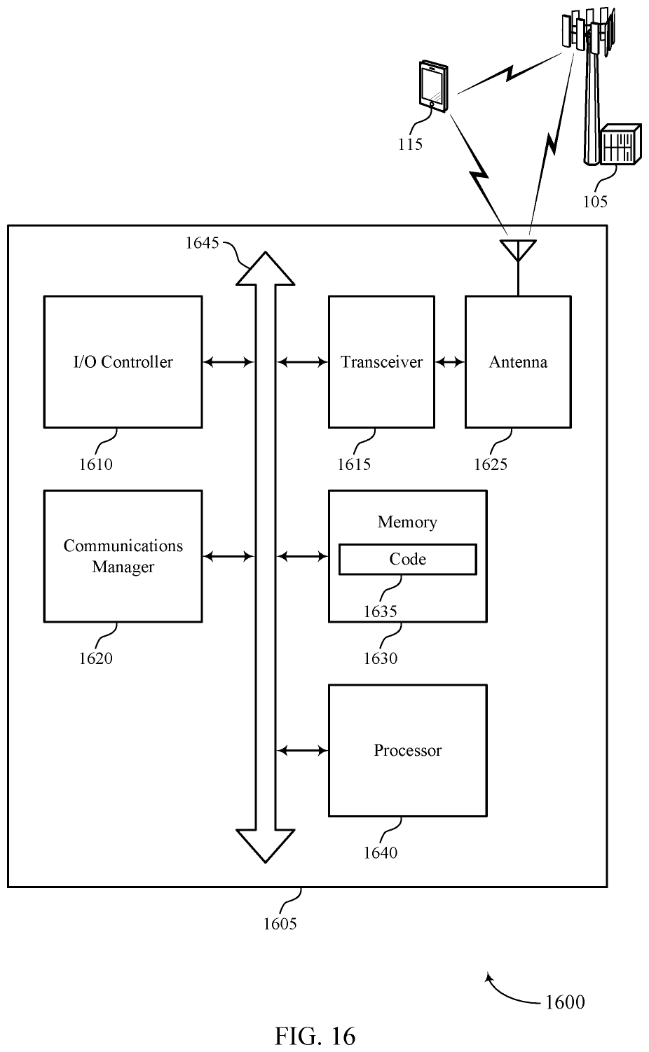

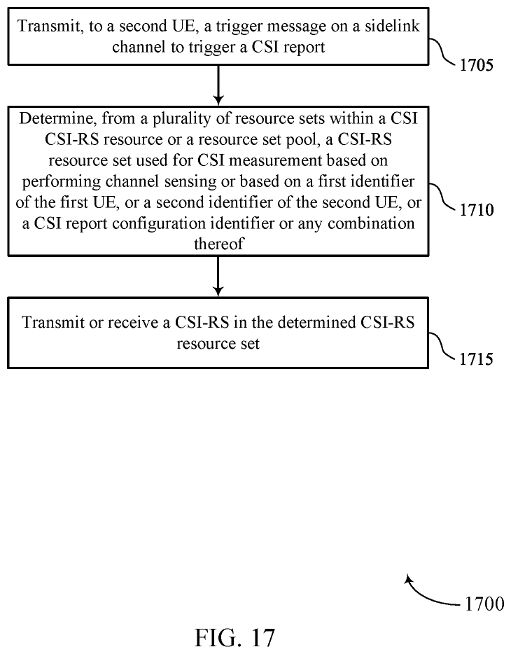

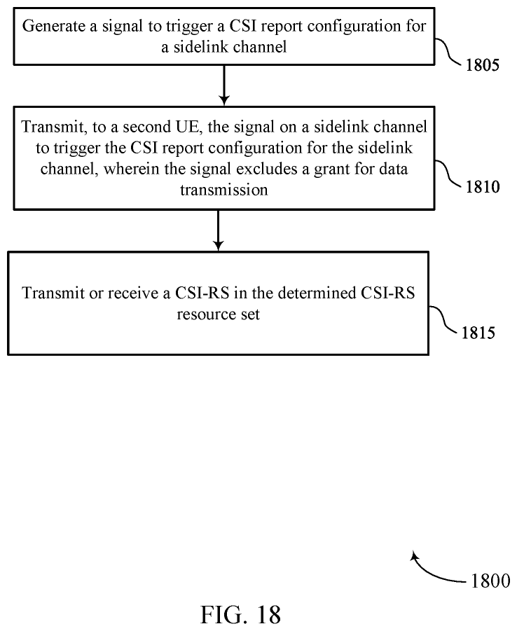

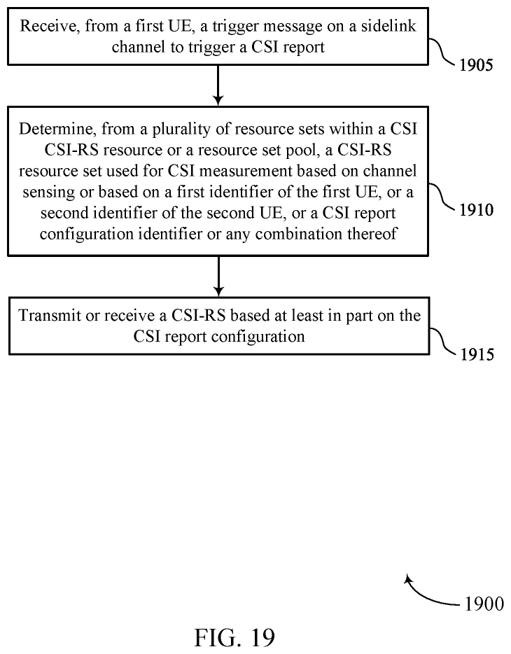

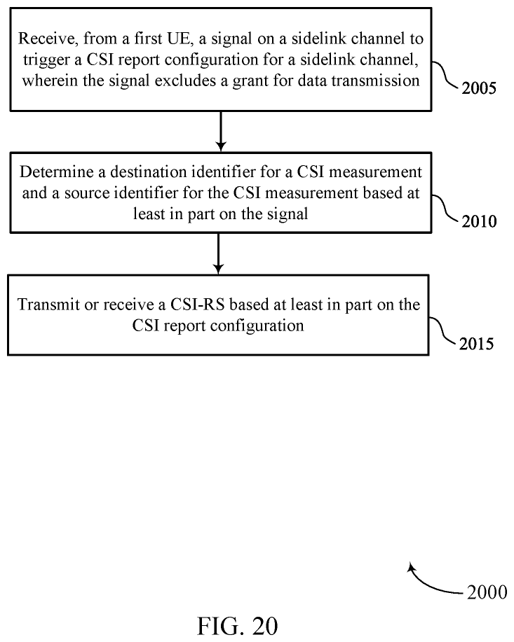

Additionally, or alternatively, the wireless communications system may support a sequence-based CSI triggering. For example, the triggering may be via a sequence transmission on a certain resource. Techniques for sequence-based triggering are described in more detail with reference to FIGS. 11 and 12.

In some cases, CSI reporting may occur on a long PUSCH channel. The long PUSCH channel may occupy multiple OFDM symbols. A transmission occasion for the long PUSCH channel may occur periodically.

UE 115-a or UE 115-b, or both, may determine PSFCH resources that carry CSI. In some cases, the PSFCH resources may be explicitly indicated by dedicated fields in SCI, such as if the trigger message is an SCI without a data grant. For sequence-based triggering, the PSFCH resource may be determined based on a sequence resource and sequence index pair or a slot index of the sequence transmission occasion or both. In some cases, the PSFCH resources may be determine based on a source-destination identifier, a triggered CSI report identifier, or a slot index of the sequence transmission occasion, or any combination thereof.

The wireless communications system 200 may also support techniques to avoid collisions on CSI-RS resources. The wireless communications system 200 may support a CSI-RS resource pool. In some cases, UE 115-a or UE 115-b, or both, may select CSI-RS resources based on sensing or based on UE identifiers.

In a first example, a CSI-RS resource or resource set pool may be broadcast by the network (e.g., via a system information block (SIB)) or the resource or resource set pool may be unicast via UE-specific RRC signaling by the network. A resource or resource set for a CSI acquisition procedure may be selected by an explicit or implicit signal conveyed in the trigger message 215 or based on an identifier of a UE 115 transmitting the CSI-RSs 220, or a combination thereof. In a first option, UE 115-a may perform sensing on the CSI-RS resource or resource set pool, select a CSI-RS resource or a CSI-RS resource set, and indicate the selected CSI-RS or CSI-RS resource set to UE 115-b via the trigger message 215. In a second option, the CSI-RS resource or CSI-RS resource set may correspond to a UE identifier of the UE 115 who is to transmit the CSI-RS (if reciprocal based CSI acquisition, UE2 to transmit the CSI-RS, so based on UE2's ID; if non-reciprocal based CSI acquisition, UE1 to transmit the CSI-RS, so based on UE1's ID). For the second option, the CSI-RS resource set may be implicitly indicated by UE ID (e.g., based on which UE 115 transmits the CSI-RSs 220). For a third option, UE 115-a and UE 115-b may each determine a subset CSI-RS resource pool based on their UE identifiers. UE 115-a may perform sensing on a subset pool of the UE 115 who is to transmit the CSI-RS (if reciprocal based CSI acquisition, UE2 to transmit the CSI-RS, so based on UE2's ID; if non-reciprocal based CSI acquisition, UE1 to transmit the CSI-RS, so based on UE1's ID) and indicate a selected CSI-RS resource to UE 115-b via the trigger message 215.

In a second example, resource or resource set pools may be exchanged by UE 115-a and UE 115-b. For example, UE 115-a and UE 115-b may exchange configurations for resource or resource set pools. UE 115-a may indicate its resource or resource set pool configuration to UE 115-b, and UE 115-b may indicate its resource or resource set pool configuration to UE 115-a. In some cases, a resource or resource set pool may be independent configured or downselected from a resource pool configured by the network.

In a third example, CSI-RS resources or resource sets may be associated with CSI report configurations. In some cases, each CSI report configuration may be associated with a CSI resource or CSI-RS resource set, and the measurement resources may be identified based on the CSI report being triggered by the trigger message. In another example, some CSI report configuration may be associated to multiple CSI-RS resources or CSI-RS resource sets. For example, a first CSI report (e.g., CSI report 1) may be associated with one CSI-RS resource set, and a second CSI report (e.g., CSI report 2) may be associated with two CSI-RS resource sets. In some cases, the CSI report configurations may have respective CSI report configuration identifiers. When UE 115-a sends the trigger message (e.g., to indicate CSI report 2 is triggered), UE 115-a may also indicate a CSI-RS resource set, which may be selected based on channel sensing. In some cases of the third example, there may be a CSI report trigger state configuration, where each trigger state may include multiple CSI reports. When configuring the CSI reports inside each trigger state, only one CSI-RS resource or CSI-RS resource set may be activated. When UE 115-a sends the trigger message to trigger a CSI report trigger state, the associated CSI-RS resource or resource set may be identified based on the CSI report being triggered.

In some cases, CSI-RS sequence generation may be based on UE identifiers. For example, a CSI-RS sequence may be generated based on transmitter and receiver UE identifiers to reduce or minimize interference. For example, CSI-RS sequences for the CSI-RSs 220 may be based on identifiers for UE 115-a and UE 115-b. For example, if UE 115-a generates a CSI-RS to transmit to UE 115-b, a sequence for the CSI-RS may be generated based on, or that is otherwise a function of, a UE identifier for UE 115-a and a UE identifier for UE 115-b.

In some cases, a UE 115 may consider spectral efficiency or CQI when determining resource selection. For example, UE 115-a may identify candidate resources by sensing and exclusion. In some wireless communications systems, the UE 115 may perform channel sensing on one or more resources to generate RSRP measurements, and any resource observed to have an RSRP below a threshold may be considered available.

For example, in a sensing phase of a procedure, the UE 115 may decode SCI and determine which resources have already been reserved. In an excluding phase of the procedure, among those reserved resources, if the RSRP (measured based on the SCI and associated DMRS) is above a threshold, the UE 115 may exclude it from the available resources, as it may already be used and lead to interference. In some cases, instead of RSRP, or in addition to RSRP, UE 115-a may check if reserved resources are below a spectral efficiency or CQI threshold. In some cases, resources measured to have a spectral efficiency for CQI above a threshold may be considered available, where the threshold for CQI or spectral efficiency may be pre-configured or determined by higher layers. If a proportion of available resources in a selection window is below a percentile threshold (e.g., below 20%), the RSRP threshold may be increased, the CQI or spectral efficiency threshold(s) may be reduced, and the process may be repeated. The candidate resource set may then be reported to the higher layers. In some cases, the reserved resources may be for sidelink communications, such as data and control signaling. UE 115-a may implement techniques using CQI or spectral energy sensing and exclusion to include CSI (e.g., resources for CSI) in the resource reservation.

In some examples, UE 115-a may implement techniques for determining an available CSI-RS resource or CSI-RS resource set. In some cases, these techniques may include one or more rules for determining the available CSI-RS resource or CSI-RS resource set. For example, if an RSRP of a CSI-RS resource or CSI-RS resource set is below a threshold, UE 115-a may identify that CSI-RS resource or CSI-RS resource set as available. The threshold may be configured via a higher layer or preconfigured at UE 115-a. After determining the available CSI-RS resources/CSI-RS resource sets, UE 115-a may randomly determine or select a CSI-RS resource or CSI-RS resource set from the available CSI-RS resources or CSI-RRS resource sets.

FIGS. 3A and 3B illustrate examples of a resource reservation 300 and a resource reservation 301, respectively, for sidelink communications in accordance with aspects of the present disclosure. Resource reservations 300 and 301 may implement aspects of or may be implemented by aspects of wireless communications system 100, wireless communications system 200, or both. In some examples, two UEs 115 may use resource reservation 300 or resource reservation 301 for sidelink communications. For example, resource reservation 300 or resource reservation 301 may be used by a first UE 115 that reserves the resources to transmit one or more sidelink messages to a second UE 115.

For sidelink communications, when the first UE 115 (e.g., source UE 115, transmitting UE 115, etc.) has data to send to the second UE 115 (e.g., destination UE 115, receiving UE 115, etc.), the first UE 115 may sense available subchannels by decoding SCIs. After decoding SCIs, the first UE 115 may know which subchannels have been reserved by other UEs 115. In some examples, among the subchannels that have been reserved by other UEs 115, the first UE 115 may determine unavailable subchannels based on which subchannels in the reserved subchannels satisfy a signal measurement threshold (e.g., reference signal received power (RSRP) threshold, reference signal strength indicator (RSSI) threshold, signal-to-noise ratio (SNR) threshold, signal-to-interference-plus-noise ratio (SINR) threshold, etc.). For example, the first UE 115 may consider the subchannels reserved by other UEs exceeding the threshold as unavailable, while others below the threshold as available resource. Subsequently, the first UE 115 may determine and reserve resources randomly from total subchannels excluding the unavailable subchannels.

As shown in the example of FIG. 3A, the first UE 115 may determine and reserve the resources randomly from the total subchannels excluding the unavailable resources according to resource reservation 300. In some examples, resource reservation 300 may be referred to as an aperiodic resource reservation. According to the aperiodic resource reservation, the first UE 115 may reserve a single subchannel 305 for up to three (3) reservations in the future (e.g., up to three (3) separate resources or subchannels reserved) or may reserve a set of subchannels 310 for up to three (3) reservations in the future. For example, the first UE 115 may reserve the set of subchannels 310 if the first UE 115 determines additional resources are needed for the upcoming sidelink transmission or additional resources may be needed for retransmission. The first UE 115 may use the reservations of the single subchannel 305 or the set of subchannels 310 to transmit sidelink information (e.g., sidelink data, sidelink configuration information, etc.) to the second UE 115. The first UE 115 may use resource reservation 300 for aperiodic sidelink transmissions to the second UE 115, such as a single sidelink transmission to the second UE 115.

Additionally or alternatively, as shown in the example of FIG. 3B, the first UE 115 may determine and reserve resources randomly from the total subchannels excluding the unavailable resources according to resource reservation 301. In some examples, resource reservation 301 may be referred to as a periodic resource reservation. According to the periodic resource reservation, the first UE 115 may reserve a subchannel pattern 315 (e.g., shown as up to three (3) subchannels but may include more or fewer subchannels) for multiple instances in time (e.g., periodically). That is, using resource reservation, the first UE 115 may reserve resources randomly such that the reserved resources (e.g., reserved subchannels) appear periodically. The first UE 115 may use resource reservation 300 for periodic sidelink transmissions to the second UE 115, such as multiple sidelink transmissions to the second UE 115 that are sent periodically by the first UE 115.

However, using resource reservation 300 or resource reservation 301 may rely on the first UE 115 randomly selecting resources or subchannels. As such, the first UE 115 may not reserve the most optimal resources from the determined available subchannels or subset of the available subchannels. In some implementations, the first UE 115 may trigger a CSI acquisition procedure to obtain CSI to determine optimal resources for the upcoming sidelink transmission(s), to determine transmission parameters for the upcoming sidelink transmission(s), or both. However, as described previously with reference to FIGS. 1 and 2, some CSI acquisition procedures may be deficient.

FIG. 4 illustrates an example of a CSI-RS configuration 400 that supports sidelink channel state information reference signal triggering and resource selection in accordance with aspects of the present disclosure. CSI-RS configuration 400 may implement aspects of or may be implemented by aspects of wireless communications system 100, wireless communications system 200, or both. For example, two UEs 115 may use CSI-RS configuration 400 to support sidelink communications between each other. In some examples, a first UE 115 may trigger a CSI acquisition with a second UE 115, where the first UE 115 transmits a CSI-RS to the second UE 115 according to CSI-RS configuration 400. Subsequently, the second UE 115 may receive the CSI-RS, perform a CSI measurement, and then transmit channel state feedback to the first UE 115 to indicate the CSI measurement. Based on the channel state feedback, the first UE 115 may obtain CSI for a subchannel to then determine a configuration or parameters for transmitting subsequent sidelink messages to the second UE 115 on that subchannel.

In some examples, when triggering the CSI acquisition, the first UE 115 may transmit a CSI request in an SCI that schedules a data transmission (e.g., sidelink data transmission). For example, the first UE 115 may reserve one or more subchannels 405 according to a resource reservation configuration as described with reference to FIG. 3 (e.g., up to three (3) subchannel reservations aperiodically or a pattern of subchannels reserved periodically). Accordingly, when transmitting the data transmission on a first reserved set of subchannels, the first UE 115 may use a slot 410 with a configuration that includes a PSCCH 415 (e.g., to indicate configuration information for the data transmission), a physical sidelink shared channel (PSSCH) 420 (e.g., to carry the data transmission along with any other information for the data transmission), a CSI-RS 425 (e.g., for the CSI acquisition), and a gap 430 (e.g., to provide a buffer between sidelink communications using slot 410 and a subsequent sidelink transmission in that same subchannel).

In some examples, PSCCH 415 may, in part, include control information via a first stage SCI (SCI-1), and PSSCH 420 may, in part, include additional information via a second stage SCI (SCI-2), and remaining resource of PSSCH may, in part, include data. Additionally or alternatively, if the first UE 115 reserves two subchannels consecutive in the frequency domain, a first subchannel of the two subchannels may look like slot 410, while a second subchannel of the two subchannels may not include a PSCCH (e.g., because there is no need of SCI as the SCI is included in the first subchannel).

As shown, the first UE 115 may transmit CSI-RS 425 in the same subchannel as PSSCH 420. Based on CSI-RS 425 being in the same subchannel as PSSCH 420, the second UE 115 may measure and report CSI (e.g., via the channel state feedback) for the subchannel(s) that contain CSI-RS 425 alone. Accordingly, the CSI reported by the second UE 115 in the channel state feedback may include CSI for the subchannels in a slot n but may not include CSI for the subchannels in a slot n+2 or a slot n+4 (e.g., subsequent resource reservations of a same reservation) because the subchannels in slot n+2 and n+4 may be different compared to subchannels in slot n, so the CSI reported using CSI-RS in slot n may not be used for slot n+2 and n+4. In some example, the second UE 115 may report the CSI (e.g., an RI for the subchannel, a CQI for the subchannel, or both) via a MAC control element (CE).

However, as discussed previously with reference to FIGS. 1 and 2, when CSI-RS 425 is transmitted on same subchannel(s) as a sidelink data transmission (e.g., carried via PSSCH 420), CSI-RS 425 may be used to determine CSI on the subchannels with which the scheduled data is transmitted rather than additional subchannels of interest (e.g., such as additional resources reserved in a same reservation as the subchannel carrying the SCI with CSI-RS 425). Additionally, the first UE 115 may transmit CSI-RS 425 with or after the sidelink data transmission, such that the sidelink data transmission may be transmitted without the benefit of CSI information on the subchannel(s) prior to the sidelink data transmission.

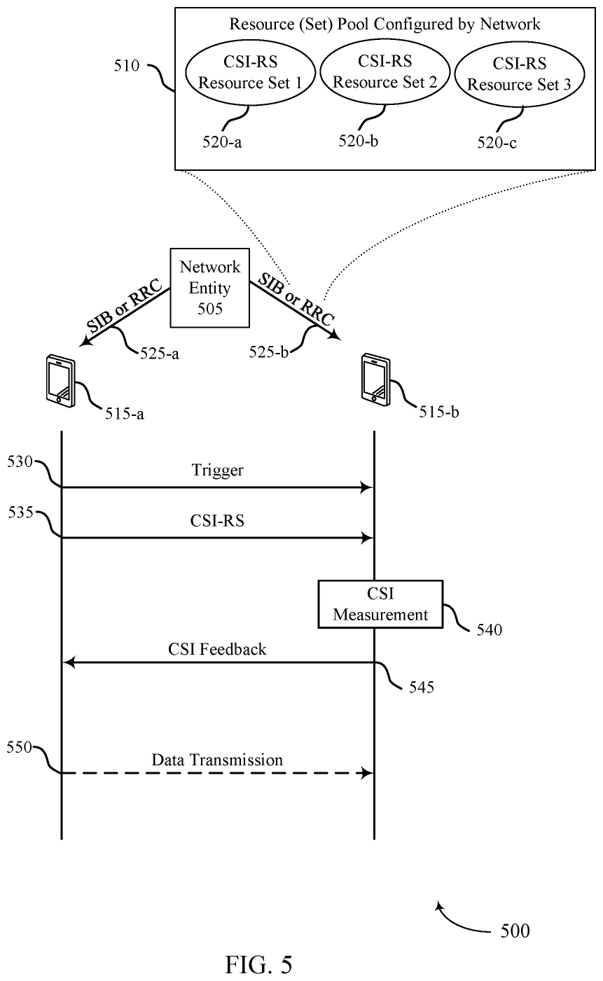

FIG. 5 illustrates an example of a process flow 500 that supports sidelink channel state information reference signal triggering and resource selection in accordance with aspects of the present disclosure.

The process flow 500 may implemented by UE 515-a, UE 515-b, or a network entity 505, or any combination thereof. UE 515-a and UE 515-b may each be an example of a UE 115 as described with reference to FIG. 1. In some examples, UE 515-a may be an example of UEA described herein, and UE 515-b may be an example of UEB. UE 515-a may trigger a CSI procedure for UE 515-a and UE 515-b. The network entity 505 may be an example of a base station 105 as described with reference to FIG. 1.

The process flow 500 shows an example of a CSI-RS resource configuration. If data transmission scheduling is decoupled, or handled separately, from a CSI request, UEs 115 may implement techniques described herein to determine CSI-RS resource selection and prevent CSI-RS collisions. The process flow 500 may show an example of a non-reciprocal based CSI procedure.

The process flow 500 may show a first example of a CSI-RS resource configuration. In the first example, a resource pool 510 may be indicated to UEs 515 via signaling 525. For example, a CSI-RS resource or resource set pool may be broadcast by the network via a SIB or sent via unicast transmission via UE-specific Uu RRC signaling. For example, the network entity 505 may indicate the resource pool 510 to UE 515-a via signaling 525-a and to UE 515-b via signaling 525-b. The resource pool 510 may include one or more CSI-RS resource sets 520. For example, the resource pool 510 may include CSI-RS resource set 520-a, CSI-RS resource set 520-b, and CSI-RS resource set 520-c.

UE 515-a and UE 515-b may select a resource or resource set for a CSI-RS measurement. In some cases, UE 515-a and UE 515-b may select the CSI-RS resource based on explicit or implicit signaling conveyed in a trigger at 530 or based on an identifier of a UE 515 that transmits the CSI-RS, or a combination thereof.

In a first option, a UE 515 triggering the CSI report may perform sensing on the resource sets in the resource pool 510. For example, UE 515-a may perform sensing on the CSI-RS resource or CSI-RS resource sets 520 in the resource pool 510, select a CSI-RS resource or CSI-RS resource set 520 based on the sensing, and indicate the selected CSI-RS resource or CSI-RS resource set 520 to UE 515-b via signaling at 530 to trigger the CSI-RS measurement. For example, UE 515-a may select a first CSI-RS resource set 520-a (e.g., CSI-RS resource set 1). UE 515-b may receive the signaling at 530 and identify the selected CSI-RS resource or CSI-RS resource set 520 based on the signaling.

In a second option, the CSI-RS resource set 520 for transmitting the CSI-RS may be based on a UE identifier of the UE 515 transmitting the CSI-RS. For example, UE 515-a may transmit the CSI-RS, so the selected CSI-RS resource set 520 may be based on a UE identifier for UE 515-a. UE 515-a and UE 515-b may identify the selected resource set 520 based on the UE identifier for UE 515-a. In some cases, the selected CSI-RS resource set 520 may be based on a UE identifier of the UE 115 who is to transmit CSI-RS. For example, if the CSI report is reciprocal based, and UE2 (e.g., UE 515-b) is to transmit the CSI-RS, then the CSI-RS resource set is based on the identifier for UE2. If the CSI report is non-reciprocal based, and UE1 (e.g., UE 515-a) is to transmit the CSI-RS, then the CSI-RS resource set may correspond to the identifier for UE1. In some cases, for the second option, the resource or resource set may be determined solely based on UE ID, and the triggering message or trigger signal may not include additional information about a resource or resource set used for the measurement. For example, there may be a one-to-one mapping between a UE identifier and a CSI-RS resource set 520. In some cases, the association between UE identifier and CSI-RS resource set may be configured by the network entity 505.

In a third option, the CSI-RS resource set 520 may be selected from a subset CSI-RS resource pool of the CSI-RS resource or resource set pool 510 based on an identifier of UE 515-a. In some cases, the CSI-RS resource set 520 for transmitting the CSI-RS may be selected based on sensing on the subset pool by UE 515-a. UE 515-a may indicate the selected CSI-RS resource set 520 to UE 515-b via triggering signaling at 530. For example, UE 515-a may determine a subset of CSI-RS resource sets 520 from the resource set pool 510, and UE 515-a may transmit a signaling to indicate the CSI-RS resource set 520 based on performing channel sensing on the resource sets within the subset. In some cases, UE 515-a may identify a subset pool based on a UE identifier for UE 515-a (e.g., as UE 515-a transmits the CSI-RS), and UE 515-a may use a trigger signal to indicate a selected CSI-RS resource set 520 from the subset pool. In some cases, the network entity 505 may configure an association between a UE identifier and a subset pool of the resource set pool 510. In some cases, the trigger signal may include an explicit indicator of the selected CSI-RS resource set 520 if the subset pool includes multiple CSI-RS resource sets 520.

At 530, UE 515-a may transmit, to UE 515-b, a trigger message on a sidelink channel to trigger a CSI report. UE 515-b may receive the trigger message on the sidelink channel triggering the CSI report. UE 515-a may determine, from a set of multiple resource sets within a CSI-RS resource or a resource set pool, a CSI-RS resource set used for CSI measurement based on performing channel sensing or based on a first identifier of the first UE 515-a or a second identifier of the second UE 515-b, or both. For example, such as for the first option, the CSI-RS resource set 520 may be determined based on performing channel sensing. In another example, such as for the second option, the CSI-RS resource set 520 may be determined based on a UE identifier for UE 515-a. In another example, such as for the third option, the CSI-RS resource set may be determined based on both channel sensing and a UE identifier for UE 515-a.

In some cases, the trigger message may trigger a CSI report without a corresponding sidelink data grant. For example, UE 515-a may generate a signal to trigger a CSI report configuration for a sidelink channel. UE 515-a may transmit, to UE 515-b, the signal on the sidelink channel to trigger the CSI report configuration for the sidelink channel, where the signal excludes a grant for data transmission.

In some cases, transmitting the trigger message may include transmitting a sequence on a sequence resource determined from a set of sequence resources, where the sequence and the determined sequence resource indicate UE 515-a, UE 515-b, and the triggered CSI report configuration. In some cases, the sequence resource may be determined based on a source-destination identifier. For example, UE 515-a may use a sequence resources associated with UE 515-a and UE 515-b as the source UE 115 and the destination UE 115. In some cases, UE 515-a may determine the sequence based on one or more of the triggered CSI report configuration and a CSI-RS resource configuration. In some other examples, the trigger message may be included in an SCI message excluding a grant for data transmission.

In some cases, UE 515-a may determine the sequence based on a destination identifier for the CSI report configuration. For example, UE 515-a may determine the sequence based on a source identifier and one or more of the triggered CSI report configuration and a CSI-RS resource configuration.

In some cases, UE 515-a may transmit a signaling to indicate the CSI-RS resource or CSI-RS resource set 520 based on performing channel sensing on a set of multiple CSI-RS resource sets 520 within the CSI-RS resource or resource set pool 510.

At 535, UE 515-a may transmit a CSI-RS to UE 515-b on the selected CSI-RS resource set 520. UE 515-b may receive the CSI-RS on the selected CSI-RS resource or CSI-RS resource set 520. At 540, UE 515-b may perform a CSI measurement and send CSI feedback (e.g., channel state feedback (CSF)) to UE 515-a at 545. In some cases, at 550, UE 515-a may send a data transmission to UE 515-b based on the CSI. In some cases, the CSI-RS may be generated based on a UE identifier for UE 515-a or a UE identifier for UE 515-b, or both.

In some cases, a frequency domain allocation for the selected CSI-RS resource set may span a total resource pool associated with the sidelink channel. In some cases, UE 515-a may transmit, via SCI or sidelink RRC, an indication that a frequency domain allocation for the CSI-RS resource or each CSI-RS resource within the CSI-RS resource set spans a subset of subchannels of the resource pool associated with the CSI-RS measurement. In some cases, UE 515-a may transmit, via SCI, an indication of a time domain allocation for the CSI-RS resource or CSI-RS resources within the CSI-RS resource set.

In some cases, a configuration for a CSI-RS resource 520 may include resource element and symbol locations, density, and transmit occasion periodicity. In some cases, each resource set may include one or more resources. In some examples, each configuration for a CSI-RS resource or CSI-RS resource set described herein, such as with reference to FIGS. 5 through 11, may include resource element and symbol locations, density, and transmit occasion periodicity.

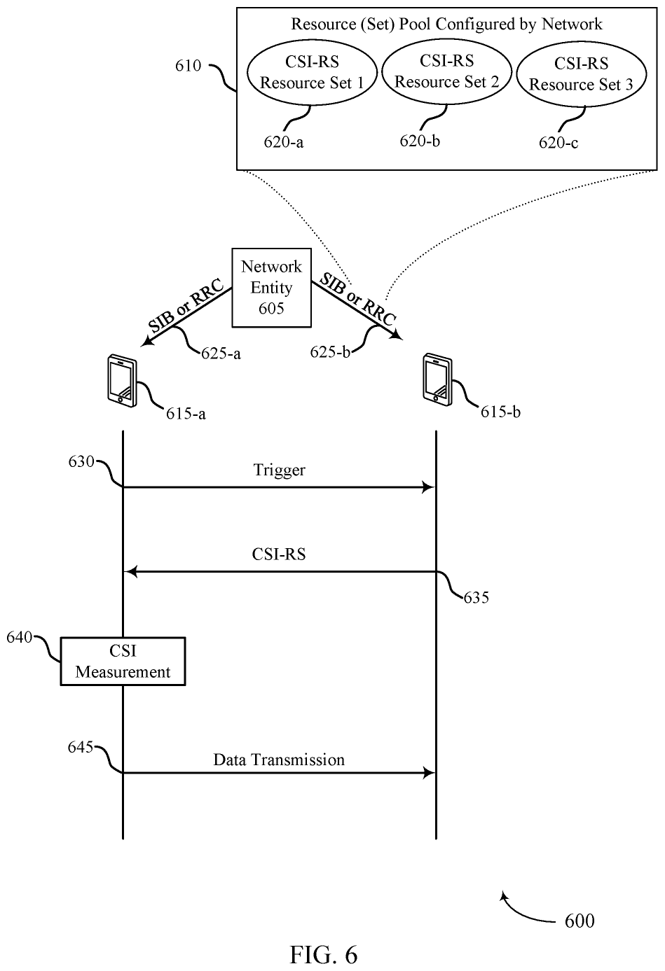

FIG. 6 illustrates an example of a process flow 600 that supports sidelink channel state information reference signal triggering and resource selection in accordance with aspects of the present disclosure.

The process flow 600 may implemented by UE 615-a, UE 615-b, or a network entity 605, or any combination thereof. UE 615-a and UE 615-b may each be an example of a UE 115 as described with reference to FIG. 1. The network entity 605 may be an example of a base station 105 as described with reference to FIG. 1.

The process flow 600 shows an example of a CSI-RS resource configuration. If data transmission scheduling is decoupled, or handled separately, from a CSI request, UEs 115 may implement techniques described herein to determine CSI-RS resource selection and prevent CSI-RS collisions. The process flow 600 may show an example of a reciprocal based CSI procedure.

The process flow 600 may show a first example of a CSI-RS resource configuration. In the first example, a resource pool 610 may be indicated to UEs 615 via signaling 625. For example, a CSI-RS resource pool or resource set pool may be broadcast by the network via a SIB or sent via unicast transmission via UE-specific Uu RRC signaling. For example, the network entity 605 may indicate the resource pool 610 to UE 615-a via signaling 625-a and to UE 615-b via signaling 625-b. The resource pool 610 may include one or more CSI-RS resource sets 620. For example, the resource pool 610 may include CSI-RS resource set 620-a, CSI-RS resource set 620-b, and CSI-RS resource set 620-c.

UE 615-a and UE 615-b may select a resource or resource set for a CSI-RS measurement. In some cases, UE 615-a and UE 615-b may select the CSI-RS resource based on explicit or implicit signaling conveyed in a trigger or based on an identifier of a UE 615 that transmits the CSI-RS, or a combination thereof.

In a first option, a UE 615 which triggers the CSI report may perform sensing on the resource sets in the resource pool 610. For example, UE 615-a may perform sensing on the CSI-RS resource or CSI-RS resource sets 620 in the resource pool 610, select a CSI-RS resource or CSI-RS resource set 620 based on the sensing, and indicate the selected CSI-RS resource or CSI-RS resource set 620 to UE 615-b via signaling to trigger the CSI-RS measurement. For example, UE 615-a may select a first CSI-RS resource set 620-a (e.g., CSI-RS resource set 1).

In a second option, the CSI-RS resource set 620 for transmitting the CSI-RS may be based on a UE identifier of the UE 615 transmitting the CSI-RS. For example, the selected CSI-RS resource set 620 may be based on a UE identifier for UE 615-b. In some cases, UE 615-a and UE 615-b may be configured with associations between UE identifiers and CSI-RS resource sets 620.

In a third option, the CSI-RS resource set may be selected from a subset CSI-RS resource pool of the CSI-RS resource or resource set pool based on an identifier of UE 615-a, and the CSI-RS resource set 620 for transmitting the CSI-RS may be selected based on sensing on the subset pool by UE 615-a. UE 615-a may indicate the selected CSI-RS resource set 620 to UE 615-b based on the triggering signaling.

At 630, UE 615-a may send a signal to trigger the CSI-RS measurement. In some cases, such as for the first option or the third option, the signal may include an indication of the selected CSI-RS resource set 620. UE 615-b may receive the signal to trigger the CSI-RS measurement at 630 and similarly identify the selected CSI-RS resource or CSI-RS resource set 620. In some cases, UE 615-b may identify the selected CSI-RS resource or CSI-RS resource set 620 based on an indication of the selection in the trigger message. At 635, UE 615-b may transmit a CSI-RS to UE 615-a on the selected CSI-RS resource of CSI-RS resource set 620. At 640, UE 615-b may perform a CSI measurement and determine CSI. In some cases, at 645, UE 615-a may send a data transmission to UE 615-b based on the CSI.

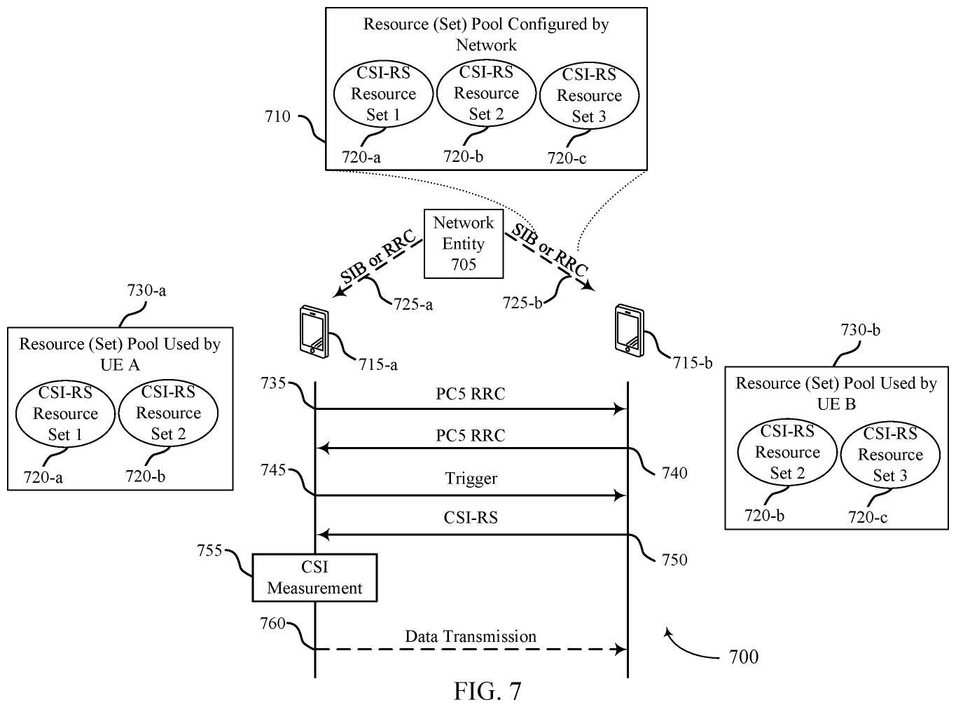

FIG. 7 illustrates an example of a process flow 700 that supports sidelink channel state information reference signal triggering and resource selection in accordance with aspects of the present disclosure. The process flow 700 may implemented by UE 715-a, UE 715-b, or a network entity 705, or any combination thereof. UE 715-a and UE 715-b may each be an example of a UE 115 as described with reference to FIG. 1. The network entity 705 may be an example of a base station 105 as described with reference to FIG. 1.

The process flow 700 shows an example of a CSI-RS resource configuration. If data transmission scheduling is decoupled, or handled separately, from a CSI request, UEs 115 may implement techniques described herein to determine CSI-RS resource selection and prevent CSI-RS collisions. The process flow 700 may show an example of a reciprocal based CSI procedure, although similar techniques may be implemented for selecting a CSI resource set for a non-reciprocal based CSI procedure.

In some cases, the process flow 700 may show a second example of a CSI-RS resource configuration. UE 715-a may be configured with a first resource set pool 730-a, including a first CSI-RS resource set 720-a and a second CSI-RS resource set 720-b. UE 715-b may be configured with a second resource set pool 730-b, including the second CSI-RS resource set 720-b and a third CSI-RS resource set 720-c. The UEs 715 may exchange the CSI-RS resource or CSI-RS resource set configuration via PC5 RRC signaling.

In some cases, the resource set pools 730 may be selected from a resource pool 710 configured by the network. In some cases, the network entity 705 may indicate the resource set pools 730 to UE 715-a and UE 715-b. For example, the network entity 705 may indicate the first resource set pool 730-a to UE 715-a via signaling 725-a, which may be a SIB or RRC signaling. The network entity 705 may indicate the second resource set pool 730-b to UE 715-b via signaling 725-b, which may similarly be a SIB or RRC signaling.

In the second example, the UEs 715 may exchange resource or resource set configuration information. For example, at 735, UE 715-a may send information for a first resource set pool 730-a to be used by UE 715-a to UE 715-b. At 740, UE 715-b may send information for a second resource set pool 730-b to be used by UE 715-b to UE 715-a. In some cases, UE 715-a and UE 715-b may exchange the resource configuration information via sidelink RRC signaling (e.g., over a PC5 interface). In some cases, the exchanged resource pools may be subsets of the network configurations.

In some examples, the UEs 715 may have PC5 links established, but the UEs 715 may not have connections established with the network. The UEs 715 may exchange resource and resource set configurations via PC5 RRC signaling.

The selected resource or resource set may be explicitly or implicitly conveyed in a trigger signal. For a reciprocal based CSI procedure, UE 715-a may perform sensing on the second resource set pool 730-b, and UE 715-b may indicate a selected CSI-RS resource or CSI-RS resource set 720 based on the sensing via the triggering signaling. For a non-reciprocal based CSI procedure, UE 715-a may perform sensing on the first resource set pool 730-a, and UE 715-b may indicate a selected CSI-RS resource or CSI-RS resource set 720 based on the sensing via the triggering signaling. In some cases, a UE 715 triggering the CSI procedure (e.g., UE 715-a in this example) may perform sensing on a resource set pool 730 configured for a UE 715 which transmits the CSI-RS.

In some cases of the second example, a CSI-RS resource set 720 may be selected based on performing channel sensing. Additionally, or alternatively, the CSI-RS resource or CSI-RS resource set 720 may be selected based on a UE identifier of UE 715-a or UE 715-b, or both. In some cases, if the CSI-RS resource or CSI-RS resource set 720 is selected based on performing sensing, the trigger signal may further explicitly indicate the selected CSI-RS resource or CSI-RS resource set 720. If the CSI-RS resource or CSI-RS resource set 720 is selected based on UE identifiers, the trigger signal may indicate which report or trigger state is triggered, and UE 715-b may identify a CSI report configuration of the triggered CSI report or trigger state.

At 745, UE 715-a may send a signal to trigger the CSI reporting procedure. UE 715-b may receive the signal triggering the CSI report. In some cases, the signal may include an indication of the selected CSI-RS resource or CSI-RS resource set 720. At 750, UE 715-b may transmit a CSI-RS to UE 715-a on the selected CSI-RS resource or CSI-RS resource set 720. At 755, UE 715-a may perform a CSI measurement and determine CSI. In some cases, at 760, UE 715-a may send a data transmission to UE 715-b based on the CSI. In other examples, UE 715-b may perform the CSI measurement in a manner analogous to the flow diagram depicted in FIG. 5. The UE 715-a may transmit a trigger signal indicating which resource or resource set 720 of resource sets 720-a and 720-b is being used by UE 715-a for CSI-RS transmission (e.g., resource set 720-a). UE 715-a may transmit a CSI-RS transmission via the resource or resource set 720-a indicated in the trigger signal. UE 715-b may perform a CSI measurement of the CSI-RS received via the resource or resource set 720-a. UE 715-b may transmit CSI feedback to UE 715-a indicating the CSI measurement of the resource set 720-a. UE 715-a may send a data transmission to UE 815-b based on the CSI measurement.

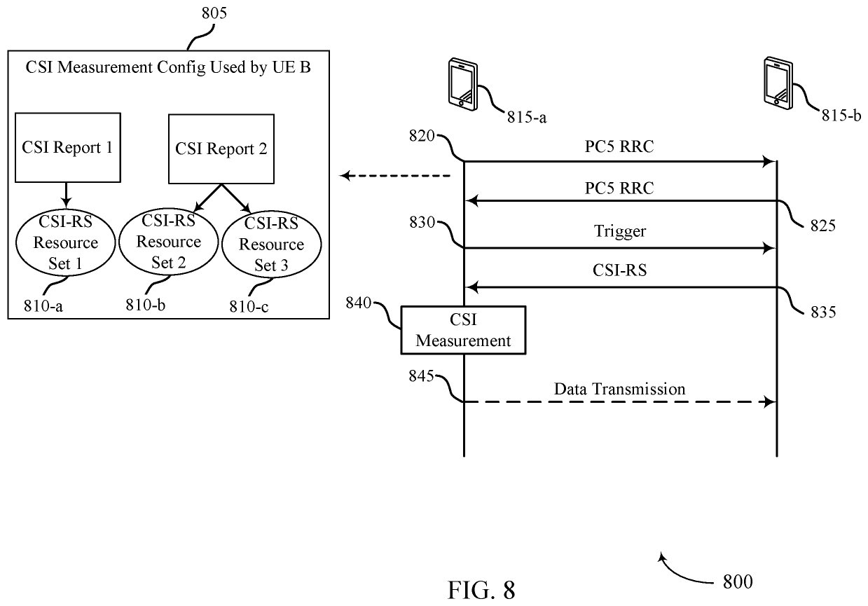

FIG. 8 illustrates an example of a process flow 800 that supports sidelink channel state information reference signal triggering and resource selection in accordance with aspects of the present disclosure. The process flow 800 may implemented by UE 815-a or UE 815-b, or both. UE 815-a and UE 815-b may each be an example of a UE 115 as described with reference to FIG. 1.

The process flow 800 shows an example of a CSI-RS resource configuration. If data transmission scheduling is decoupled, or handled separately, from a CSI request, UEs 115 may implement techniques described herein to determine CSI-RS resource selection and prevent CSI-RS collisions. The process flow 800 may show an example of a reciprocal based CSI procedure, although similar techniques may be implemented for selecting a CSI resource set for a non-reciprocal based CSI procedure.

The process flow 800 may show a third example of a CSI-RS resource configuration. UE 815-a may be configured with a CSI measurement configuration 805. The CSI measurement configuration 805 may include an association between resources or resource sets and CSI report configurations. For example, CSI-RS resource set 810-a may be associated with CSI report 1, and CSI-RS resource set 810-b and CSI-RS resource set 810-c may be associated with CSI report 2. In some cases, CSI report 1 and CSI report 2 may be associated with different types of CSI, such as reciprocal based or non-reciprocal based CSI.

UE 815-a and UE 815-b may exchange report, resource or resource set configuration information, or any combination thereof. In some cases, the CSI measurement configuration of UE 815-a and UE 815-b may comprises association between resource or resource sets and CSI report configurations. In some cases, UE 815-a and UE 815-b may indicate the associations. For example, at 820 and 825, UE 815-a and UE 815-b may exchange resource/resource set and CSI report configuration association information.

In some cases, UE 815-a and UE 815-b may each determine an association between a set of multiple CSI report configurations and the set of multiple resource sets or the resource of multiple resources. For example, UE 815-a and UE 815-b may determine that a first CSI-RS resource or a first CSI-RS resource set 810-a is associated with CSI report configuration 1, and CSI resource or CSI-RS resource set 810-b and CSI resource or CSI-RS resource set 810-c are associated with CSI report configuration 2.

UE 815-a may send a signal to UE 815-b at 830 to trigger a CSI report. The trigger signal may indicate which report or trigger state is triggered, and UE 815-b may identify a CSI report configuration of the triggered CSI report or trigger state. In some cases, the signal may indicate or trigger which CSI report configuration to apply of the multiple available CSI report configurations exchanged UE 815-a and UE 815-b. UE 815-a and UE 815-b may determine, based on the association, a CSI-RS resource or resource set according to a CSI report configuration for a triggered CSI report. For example, the signal may trigger CSI report configuration 2 is to be applied. In some cases, the signal may indicate a CSI-RS resource or CSI-RS resource set 810. For example, the signal may indicate CSI-RS resource or CSI-RS resource set 810-c, as there may be multiple CSI-RS resources or resource sets associated with CSI report configuration 2. In some cases, CSI-RS resource or CSI-RS resource set 810-c may be selected based on UE 815-a performing channel sensing on the CSI-RS resource or CSI-RS resource sets 810 associated with CSI report configuration 2.

In some cases of the third example, each CSI report configuration may be associated with one CSI-RS resource or CSI-RS resource set 810. In this example, the measurement resource is determined based on the CSI report being triggered. For example, UE 815-b may determine a measurement resource based on a CSI report configuration identifier, indicating a CSI report configuration associated with one CSI-RS resource or one CSI-RS resource set 810. In another example, a CSI report configuration may be associated to multiple CSI-RS resources or CSI-RS resource sets 810. In some cases of the third example, there may be a CSI report trigger state configuration, where each trigger state may include multiple CSI reports. When configuring the CSI reports inside each trigger state, only one CSI-RS resource or CSI-RS resource set 810 may be activated. In this case, similar to the case where each report configuration is associated to one CSI-RS resource or resource set, the measurement resource is determined based on the CSI report being triggered.

UE 815-b may receive the signal at 830, triggering one of the CSI report configurations (e.g., CSI report configuration 2). UE 815-b may transmit one or more CSI-RS transmissions via the CSI-RS resource set 810 at 835 corresponding to the triggered CSI reporting configuration. For example, UE 815-b may transmit CSI-RS on one or both of CSI-RS Resource Sets 2 and 3. At 840, UE 815-a may perform a CSI measurement of one or both of CSI-RS Resource Sets 2 and 3. In some cases, at 845, UE 815-a may send a data transmission to UE 815-b based on the one or more CSI measurements. In other examples, UE 815-b may perform the CSI measurement in a manner analogous to the flow diagram depicted in FIG. 5. The UE 815-a may transmit a trigger signal, indicating a CSI report or trigger state corresponding to a CSI report configuration of the multiple available CSI report configurations exchanged UE 815-a and UE 815-b. UE 815-a may transmit one or more CSI-RS transmissions via the CSI-RS resource set 810 indicated in the trigger signal (e.g., CSI report configuration 2). UE 815-b may perform a CSI measurement of the CSI-RS received on one or both of CSI-RS Resource Sets 2 and 3 corresponding to the indicated CSI report configuration. UE 815-b may transmit CSI feedback to UE 815-a indicating the one or more CSI measurements of one or both of CSI-RS Resource Sets 2 and 3. UE 815-a may send a data transmission to UE 815-b based on the one or more CSI measurements.

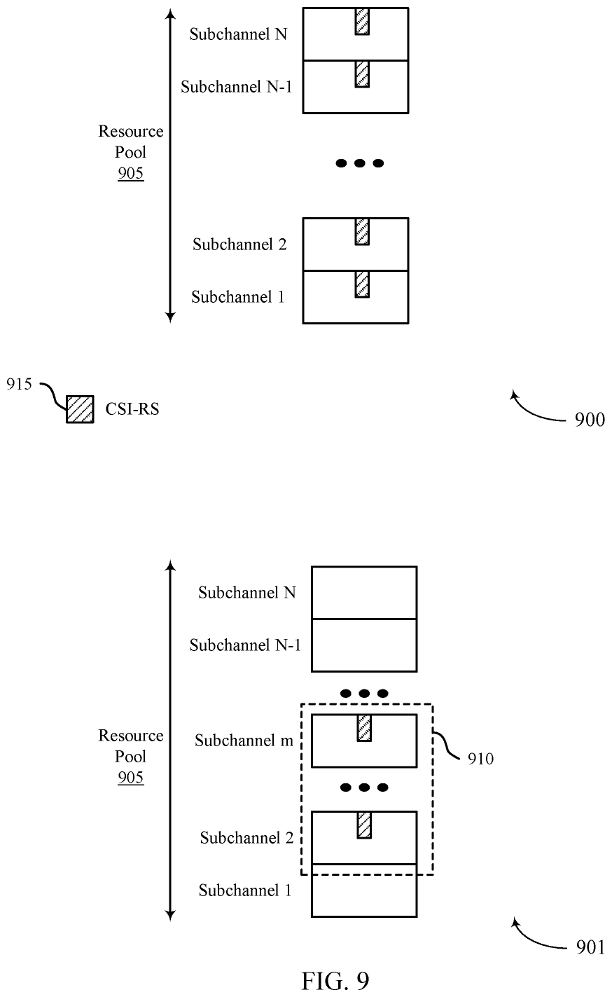

FIG. 9 illustrates examples of CSI-RS frequency resource allocation schemes 900 and 901 that supports sidelink channel state information reference signal triggering and resource selection in accordance with aspects of the present disclosure.

In some cases, CSI-RS locations (e.g., for a CSI-RS 915) may be configured within a selected CSI-RS resource or a selected CSI-RS resource set according to a CSI-RS frequency resource allocation scheme 900 or a CSI-RS frequency resource allocation scheme 901. For example, a CSI-RS resource set selected by a UE 115 as described with reference to FIGS. 2 through 8 may have a frequency resource allocation configured according to the CSI-RS frequency resource allocation schemes 900 or 901.

For example, according to the CSI-RS frequency resource allocation scheme 900, the frequency allocation of the CSI-RS 915 may be wideband across all subchannels of a resource pool 905 For the wideband configuration, the CSI-RS may span the resource pool which is configured for sidelink communication, which may include subchannels used for data as well as control signaling. The CSI-RS may also span the resource pool within the active BWP. If some resource pool is outside the active BWP, the CSI-RS is not transmitted on the subchannels outlying the active BWP.

According to the CSI-RS frequency resource allocation scheme 901, CSI-RS 915 may be transmitted on subchannels configured in a CSI report configuration or subchannels indicated in a dedicated field of SCI. In some cases, the SCI may be an example of an SCI which does not include a data grant and triggers a CSI report. Additionally or alternatively, the network may configure UEs 115 with a CSI report configuration indicating a frequency resource allocation scheme for CSI-RS resources or CSI-RS resource sets. For example, CSI-RS may be transmitted on a set of subchannels 910 within the resource pool. In some cases, the set of subchannels 910 may be configured in a CSI report configuration or configured via CSI-RS FDRA in SCI. In some cases, the set of subchannels 910 may span a portion of the resource pool 905. The FDRA indication may include a starting subchannel index and a total number of subchannels. If the indicated FDRA is outside the active BWP, the CSI-RS is only transmitted on the subchannels within the active BWP.

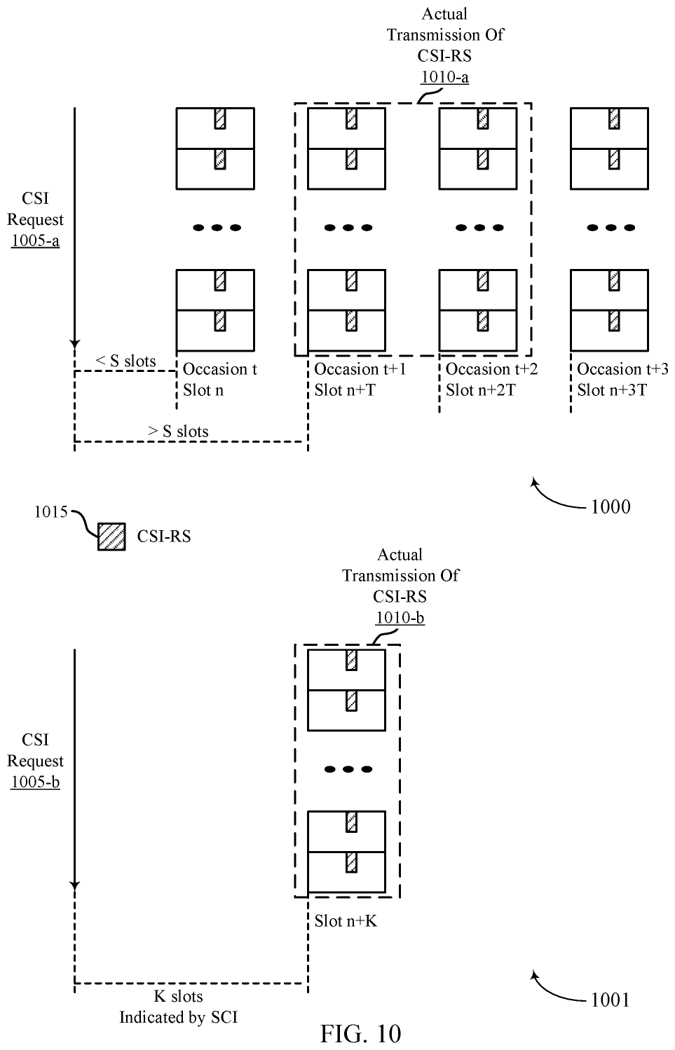

FIG. 10 illustrates examples of CSI-RS time resource allocation schemes 1000 and 1001 that support sidelink channel state information reference signal triggering and resource selection in accordance with aspects of the present disclosure.

In some cases, CSI-RS time domain locations (e.g., for a CSI-RS 1015) may be configured according to a CSI-RS time resource allocation scheme 1000 or a CSI-RS time resource allocation scheme 1001. In some cases, the selected CSI-RS resource or the selected CSI-RS resource set may be an example of a CSI-RS resource or a CSI-RS resource set as described with reference to FIGS. 2 through 9.

For example, according to the CSI-RS time resource allocation scheme 1000, periodic CSI-RS transmission occasion may be defined, and the slot offset n and periodicity T are configured via SIB, or Uu RRC signaling, or PC5 RRC signaling. The actual transmission of CSI-RS may be performed on one or more consecutive transmission occasions. In FIG. 10, a CSI request may be received at 1005-a. CSI-RS may be transmitted in a most recent N>=1 occasions after S slots of receiving the trigger, where N and/or S may be configured or preconfigured (e.g., by a specification for a wireless communications system) or dynamically indicated via SCI or MACCE. For example, CSI-RS may be transmitted starting with resources 1010-a, which may be more than S slots after receiving the CSI request at 1005-a. For example, S slots after receiving the CSI request at 1005-a, CSI-RS may be communicated for N transmission occasions. In some cases, S may be configured for the selected CSI-RS resource or CSI-RS resource set.

According to the CSI-RS time resource allocation scheme 1001, a CSI request may be received at slot n 1005-b, the time allocation may be determined by explicit signaling in a dedicated field of SCI. For example, a field in SCI may indicate an offset of K slots from when the CSI request is received, such that CSI-RS 1015 may be transmitted using resources 1010-b at slot n+K. In some cases, the SCI may be an example of an SCI which does not include a data grant and triggers a CSI report. Additionally or alternatively, the network may configure UEs 115 with a CSI report configuration indicating a time resource allocation scheme for CSI-RS resources or CSI-RS resource sets.

FIG. 11 illustrates an example of a CSI triggering sequence resource configuration 1100 that supports sidelink channel state information reference signal triggering and resource selection in accordance with aspects of the present disclosure.

In some wireless communications systems, a CSI report is requested in an SCI that schedules a data transmission. The CSI reporting may occur after data transmission. In these systems, the CSI obtain from the reporting may be used for later data transmissions, but not for the data transmission scheduled by the SCI which requests the CSI report. Additionally, the CSI report may indicate CSI for a subchannel used for the CSI measurement, but not other subchannels. Therefore, if the later data transmissions occur on different subchannels, the CSI report may not be as useful. For example, in an aperiodic resource reservation, a transmitting UE 115 may reserve three different subchannels, but CSI-RS is only transmitted on the first subchannel.

Techniques described herein support decoupling data transmission and CSI acquisition. For example, the sequence-based CSI-RS triggering scheme may include techniques for triggering CSI by sending a sequence on a sequence resource instead of sending SCI to trigger CSI reporting. In some cases, these techniques may be implemented to trigger a CSI report, or to send a trigger message, as described with reference to FIGS. 2 through 10. These techniques may enable more efficient CSI reporting, which may be used for the same subchannels as data communications or be performed prior to a data transmission, or both.

The CSI reporting may be triggered based on a sequence transmission on a certain resource. Each sequence resource may occupy N subchannels and one symbol. A transmission occasion may be periodic, and each occasion may include M symbols. The transmitting UE may transmit the sequence using the selected resource in one occasion. In some cases, different resources may have different sizes or periodicities.

The example of the CSI triggering sequence resource configuration 1100 may include four sequence resources. For example, the CSI triggering sequence resource configuration 1100 includes a first sequence resource 1105, a second sequence resource 1110, a third sequence resource 1115, and a fourth sequence resource 1120. The sequence resources may each span a symbol and four subchannels. In other examples, the sequence resources may have different sizes. In some cases, the sequence resources may have a periodicity of T. In other examples, the sequence resources may have different periodicities or a different periodicity.

FIG. 12 illustrates examples of CSI triggering sequence configurations 1200 and 1201 that support sidelink channel state information reference signal triggering and resource selection in accordance with aspects of the present disclosure.

The CSI triggering sequence configurations 1200 and 1201 may provide examples for a CSI triggering mechanism by transmitting a sequence with a certain sequence index on a certain sequence resource. A UE 115 may transmit a sequence with a certain sequence index in a certain sequence resource to trigger a CSI between certain UEs 115 with a certain CSI report configuration or a certain CSI report trigger state which may comprise one or more CSI reports. The description hereafter only focus on the case with a certain CSI report configuration, but it also applies to the case with a certain CSI report trigger state. Different sequence indexes and sequence resources may correspond to different source-destination pairs for UEs 115 and different CSI report configurations. There may be an N-to-1 mapping between a sequence resource and sequence index to a source UE identifier and a destination UE identifier. For example, a UE 115 may trigger 1 out of N CSI reports for a certain source-destination pair of UEs 115.

The CSI triggering sequence configuration 1200 may be an example of a first option for the triggering mechanism. In the first option, a sequence resource may be assigned a source-destination ID pair. For example, sequence resource 1 may be used to trigger a CSI report requested by UE1 to UE2. Sequence resource 2 may be used to trigger a CSI report requested by UE1 to UE3.

In the first option, different sequences may be used to request different CSI report configurations. In some cases, the UE1 may use a sequence index to convey 1 out of N CSI reports to UE2. For example, the UE1 may use sequence index 1 on sequence resource 1 to request CSI report 1 for UE 2 and use sequence index 2 on sequence resource 2 to request CSI report 2 for UE2. In some cases, the UE1 may use a sequence index to convey 1 out of N CSI-RS resource configurations to UE2. For example, sequence and sequence resource pair 1205-a may be used by UE1 to trigger CSI report 1 for UE2. For example, the sequence and sequence resource pair 1205-a may trigger a non-reciprocal based CSI requested by UE1 to UE2. In this case, upon detecting the sequence and sequence resource pair 1205-a, UE2 may receive CSI-RS transmitted from UE1 and UE2 will measure the CSI-RS to determine CSI and report the CSI. Sequence and sequence resource pair 1205-b may be used by UE1 to trigger CSI report 2 for UE2. For example, the sequence and sequence resource pair 1205-a may trigger a reciprocal based CSI requested by UE1 to UE2. Similarly, UE1 may use sequence index 1 on resource 2 to trigger CSI report 1 for UE3, and may use sequence index 2 on resource 2 to trigger CSI report 2 for UE3. UE2 may similarly identify a CSI report configuration, source UE 115, and destination UE 115 based on the sequence and sequence resource pair indicated by UE1.

The CSI triggering sequence configuration 1201 may be an example of a second option for the triggering mechanism. In this option, a particular sequence resource is assigned to a particular destination identifier, while a particular sequence resource is assigned to a source identifier and a CSI report configuration jointly. In some cases, when UE1 want to trigger a CSI report for UE2, UE1 may use a sequence resource corresponding to UE2's identifier. UE1 may use a sequence index to indicate that UE1 as source identifier and 1 out of N CSI report configurations, or 1 out of N CSI-RS resource configurations to UE2 jointly. For example, a first sequence resource is assigned to UE2 if UE2 is the destination UE. Sequences 1 through 4 may convey different source UEs 115 and different CSI report configurations. For example, UE1 may use sequence 1 to indicate UE1 as the source UE 115 and CSI report 1 as the CSI report configuration. UE1 may use sequence 2 to indicate UE1 as the source UE 115 and CSI report 2 as the CSI report configuration. UE3 may use sequence 3 to indicate UE3 as the source UE 115 and CSI report 1 as the CSI report configuration, and UE3 may use sequence 4 to indicate UE3 as the source UE 115 and CSI report 2 as the CSI report configuration. Therefore, sequence and sequence resource pair 1205-c may indicate UE2 as the destination UE 115, which UE is the source UE (e.g., UE1 or UE2) as the source UE 115, and which CSI report is. In this case, upon detecting the sequence and sequence resource pair 1205-c, if the triggered CSI report is reciprocal based CSI, UE2 will transmit the CSI-RS and UE1 or UE3 will perform CSI measurement if sequence index 1 or 3 is used, respectively; if the triggered CSI report is non-reciprocal based CSI, UE2 will receive CSI-RS transmitted from UE1 or UE3 if the sequence index 1 or 3 is used, respectively and UE2 will measure the CSI-RS to determine CSI and report the CSI. Similarly, sequence resource 2 is assigned to UE4 if UE4 it the destination UE. Sequences 1 through 4 may convey different source UEs 115 and different CSI report configurations. In this option, each UE may monitor only its assigned sequence resource to identify which UE transmits a CSI request to itself and which CSI report is triggered. In this option, if a UE wants to trigger a CSI report for another UE, the first UE may transmit the sequence using the sequence resource assigned to the destination UE.

In some examples, a sequence resource may correspond a source identifier and a sequence index may correspond to a destination identifier and CSI report identifier. For example, sequence resource 1 may be associated with UE1 as the source UE 115, and the different sequences may be associated with different destination identifiers and CSI report configurations. In this option, each UE may monitor all sequence resources to identify which UE transmits a CSI request to itself and which CSI report is triggered. In this option, if a first UE wants to trigger a CSI report for another UE, the UE may transmit the sequence using the sequence resource assigned to the first UE.

A UE 115 may monitor the sequence resources for transmission of sequences. For example, a second UE 115 may receive a sequence on a sequence resource and determine a source UE identifier, a destination UE identifier, and a CSI report configuration for a CSI report based on the sequence resource and sequence.

FIG. 13 shows a block diagram 1300 of a device 1305 that supports sidelink channel state information reference signal triggering and resource selection in accordance with aspects of the present disclosure. The device 1305 may be an example of aspects of a UE 115 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to sidelink channel state information reference signal triggering and resource selection). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to sidelink channel state information reference signal triggering and resource selection). In some examples, the transmitter 1315 may be co-located with a receiver 1310 in a transceiver module. The transmitter 1315 may utilize a single antenna or a set of multiple antennas.

The communications manager 1320, the receiver 1310, the transmitter 1315, or various combinations thereof or various components thereof may be examples of means for performing various aspects of sidelink channel state information reference signal triggering and resource selection as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 1320 may be configured to perform various operations (e.g., receiving, monitoring, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to receive information, transmit information, or perform various other operations as described herein.

The communications manager 1320 may support wireless communication at a first UE in accordance with examples as disclosed herein. For example, the communications manager 1320 may be configured as or otherwise support a means for transmitting, to a second UE, a trigger message on a sidelink channel to trigger a CSI report. The communications manager 1320 may be configured as or otherwise support a means for determining, from a set of multiple resource sets within a CSI-RS resource or a resource set pool, a CSI-RS resource set used for CSI measurement based on performing channel sensing or based on a first identifier of the first UE, or a second identifier of the second UE, or a CSI report configuration identifier or any combination thereof. The communications manager 1320 may be configured as or otherwise support a means for transmitting or receiving a CSI-RS in the determined CSI-RS resource set.

Additionally or alternatively, the communications manager 1320 may support wireless communication at a first UE in accordance with examples as disclosed herein. For example, the communications manager 1320 may be configured as or otherwise support a means for generating a signal to trigger a CSI report configuration for a sidelink channel. The communications manager 1320 may be configured as or otherwise support a means for transmitting, to a second UE, the signal on a sidelink channel to trigger the CSI report configuration for the sidelink channel, where the signal excludes a grant for data transmission. The communications manager 1320 may be configured as or otherwise support a means for transmitting or receiving a CSI-RS based on the CSI report configuration.

Additionally or alternatively, the communications manager 1320 may support wireless communication at a second UE in accordance with examples as disclosed herein. For example, the communications manager 1320 may be configured as or otherwise support a means for receiving, from a first UE, a trigger message on a sidelink channel to trigger a CSI report. The communications manager 1320 may be configured as or otherwise support a means for determining, from a set of multiple resource sets within a CSI-RS resource or a resource set pool, a CSI-RS resource set used for CSI measurement based on channel sensing or based on a first identifier of the first UE, or a second identifier of the second UE, or a CSI report configuration identifier, or any combination thereof. The communications manager 1320 may be configured as or otherwise support a means for transmitting or receiving a CSI-RS in the determined CSI-RS resource set.

Additionally or alternatively, the communications manager 1320 may support wireless communication at a second UE in accordance with examples as disclosed herein. For example, the communications manager 1320 may be configured as or otherwise support a means for receiving, from a first UE, a signal on a sidelink channel to trigger a CSI report configuration for a sidelink channel, where the signal excludes a grant for data transmission. The communications manager 1320 may be configured as or otherwise support a means for determining a destination identifier for a CSI measurement and a source identifier for the CSI measurement based on the signal. The communications manager 1320 may be configured as or otherwise support a means for transmitting or receiving a CSI-RS based on the CSI report configuration.

By including or configuring the communications manager 1320 in accordance with examples as described herein, the device 1305 (e.g., a processor controlling or otherwise coupled to the receiver 1310, the transmitter 1315, the communications manager 1320, or a combination thereof) may support techniques for decoupling sidelink data scheduling from sidelink CSI requests. These techniques may support performing sidelink CSI on subchannels which may be used for sidelink data transmissions. Additionally, sidelink CSI may be performed and sidelink CSI may be determined before a sidelink data transmission, so the sidelink CSI may be implemented to improve the sidelink data transmission. Additionally, techniques are provided to reduce resource collisions of CSI-RS resources. For example, these techniques may be implemented to reduce a likelihood of CSI-RS collision, such as if CSI requests are decoupled from sidelink data scheduling.

FIG. 14 shows a block diagram 1400 of a device 1405 that supports sidelink channel state information reference signal triggering and resource selection in accordance with aspects of the present disclosure. The device 1405 may be an example of aspects of a device 1305 or a UE 115 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for receiving information such as packets, user data, control information, or any combination thereof associated with various information channels (e.g., control channels, data channels, information channels related to sidelink channel state information reference signal triggering and resource selection). Information may be passed on to other components of the device 1405. The receiver 1410 may utilize a single antenna or a set of multiple antennas.

The transmitter 1415 may provide a means for transmitting signals generated by other components of the device 1405. For example, the transmitter 1415 may transmit information such as packets, user data, control information, or any combination thereof associated with various information channels (e.g., control channels, data channels, information channels related to sidelink channel state information reference signal triggering and resource selection). In some examples, the transmitter 1415 may be co-located with a receiver 1410 in a transceiver module. The transmitter 1415 may utilize a single antenna or a set of multiple antennas.

The device 1405, or various components thereof, may be an example of means for performing various aspects of sidelink channel state information reference signal triggering and resource selection as described herein. For example, the communications manager 1420 may include a trigger message transmitting component 1425, a resource set determining component 1430, a trigger signal generating component 1435, a trigger signal transmitting component 1440, a trigger message receiving component 1445, a trigger signal receiving component 1450, or any combination thereof. The communications manager 1420 may be an example of aspects of a communications manager 1320 as described herein. In some examples, the communications manager 1420, or various components thereof, may be configured to perform various operations (e.g., receiving, monitoring, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to receive information, transmit information, or perform various other operations as described herein.

The communications manager 1420 may support wireless communication at a first UE in accordance with examples as disclosed herein. The trigger message transmitting component 1425 may be configured as or otherwise support a means for transmitting, to a second UE, a trigger message on a sidelink channel to trigger a CSI report. The resource set determining component 1430 may be configured as or otherwise support a means for determining, from a set of multiple resource sets within a CSI-RS resource or a resource set pool, a CSI-RS resource set used for CSI measurement based on performing channel sensing or based on a first identifier of the first UE, or a second identifier of the second UE, or a CSI report configuration identifier, or any combination thereof. The resource set determining component 1430 may be configured as or otherwise support a means for transmitting or receiving a CSI-RS in the determined CSI-RS resource set.

Additionally or alternatively, the communications manager 1420 may support wireless communication at a first UE in accordance with examples as disclosed herein. The trigger signal generating component 1435 may be configured as or otherwise support a means for generating a signal to trigger a CSI report configuration for a sidelink channel. The trigger signal transmitting component 1440 may be configured as or otherwise support a means for transmitting, to a second UE, the signal on a sidelink channel to trigger the CSI report configuration for the sidelink channel, where the signal excludes a grant for data transmission. The resource set determining component 1430 may be configured as or otherwise support a means for transmitting or receiving a CSI-RS based on the CSI report configuration.

Additionally or alternatively, the communications manager 1420 may support wireless communication at a second UE in accordance with examples as disclosed herein. The trigger message receiving component 1445 may be configured as or otherwise support a means for receiving, from a first UE, a trigger message on a sidelink channel to trigger a CSI report. The resource set determining component 1430 may be configured as or otherwise support a means for determining, from a set of multiple resource sets within a CSI-RS resource or a resource set pool, a CSI-RS resource set used for CSI measurement based on channel sensing or based on a first identifier of the first UE, or a second identifier of the second UE, or a CSI report configuration identifier, or any combination thereof. The resource set determining component 1430 may be configured as or otherwise support a means for transmitting or receiving a CSI-RS in the determined CSI-RS resource set.

Additionally or alternatively, the communications manager 1420 may support wireless communication at a second UE in accordance with examples as disclosed herein. The trigger signal receiving component 1450 may be configured as or otherwise support a means for receiving, from a first UE, a signal on a sidelink channel to trigger a CSI report configuration for a sidelink channel, where the signal excludes a grant for data transmission. The trigger signal receiving component 1450 may be configured as or otherwise support a means for determining a destination identifier for a CSI measurement and a source identifier for the CSI measurement based on the signal. The resource set determining component 1430 may be configured as or otherwise support a means for transmitting or receiving a CSI-RS based on the CSI report configuration.

FIG. 15 shows a block diagram 1500 of a communications manager 1520 that supports sidelink channel state information reference signal triggering and resource selection in accordance with aspects of the present disclosure. The communications manager 1520 may be an example of aspects of a communications manager 1320, a communications manager 1420, or both, as described herein. The communications manager 1520, or various components thereof, may be an example of means for performing various aspects of sidelink channel state information reference signal triggering and resource selection as described herein. For example, the communications manager 1520 may include a trigger message transmitting component 1525, a resource set determining component 1530, a trigger signal generating component 1535, a trigger signal transmitting component 1540, a trigger message receiving component 1545, a trigger signal receiving component 1550, a sidelink RRC component 1555, a sequence generating component 1560, a resource configuration component 1565, a triggering sequence component 1570, a triggering SCI component 1575, a resource selection component 1580, or any combination thereof. Each of these components may communicate, directly or indirectly, with one another (e.g., via one or more buses).

The communications manager 1520 may support wireless communication at a first UE in accordance with examples as disclosed herein. The trigger message transmitting component 1525 may be configured as or otherwise support a means for transmitting, to a second UE, a trigger message on a sidelink channel to trigger a CSI report. The resource set determining component 1530 may be configured as or otherwise support a means for determining, from a set of multiple resource sets within a CSI-RS resource or a resource set pool, a CSI-RS resource set used for CSI measurement based on performing channel sensing or based on a first identifier of the first UE, or a second identifier of the second UE, or a CSI report configuration identifier, or any combination thereof. The resource set determining component 1530 may be configured as or otherwise support a means for transmitting or receiving a CSI-RS in the determined CSI-RS resource set.

In some examples, to support determining the CSI-RS resource set, the resource set determining component 1530 may be configured as or otherwise support a means for transmitting a signaling to indicate the CSI-RS resource set based on performing channel sensing on the set of multiple resource sets within a CSI-RS resource or resource-set pool.

In some examples, to support determining the CSI-RS resource set, the resource set determining component 1530 may be configured as or otherwise support a means for determining the CSI-RS resource set based on ID of first UE, ID of the second UE or both.

In some examples, to support determining the CSI-RS resource set, the resource set determining component 1530 may be configured as or otherwise support a means for determining a subset of CSI-RS resource sets from the resource set pool, and transmitting a signaling to indicate the CSI-RS resource set based on performing channel sensing on the set of multiple resource sets within the subset.

In some examples, the resource set determining component 1530 may be configured as or otherwise support a means for determining the subset of CSI-RS resource sets from the resource set pool based on one or more of the first identifier of the first UE or the second identifier of the second UE, or both, a resource configuration or resource set configuration exchanged with the second UE via sidelink Radio Resource Control signaling, or an association between the CSI report and the subset of the set of multiple resource sets.

In some examples, to support transmitting the trigger message, the trigger message transmitting component 1525 may be configured as or otherwise support a means for determining an association between a set of multiple CSI report configurations and the set of multiple resource sets. In some examples, to support transmitting the trigger message, the trigger message transmitting component 1525 may be configured as or otherwise support a means for determining, based on the association, the CSI-RS resource set according to a CSI report configuration for the triggered CSI report.

In some examples, the sidelink RRC component 1555 may be configured as or otherwise support a means for transmitting, to the second UE via sidelink Radio Resource Control (RRC) signaling, an indication of the association between the CSI-RS resource set and the CSI report configuration, used by first UE.

In some examples, the sidelink RRC component 1555 may be configured as or otherwise support a means for receiving, from the second UE via sidelink Radio Resource Control (RRC) signaling, an indication of the association between the CSI-RS resource set and the CSI report configuration, used by the second UE.

In some examples, the sidelink RRC component 1555 may be configured as or otherwise support a means for exchanging, with the second UE via sidelink Radio Resource Control (RRC) signaling, a first configuration for a first subset of the set of multiple resource sets configured for the first UE and a second configuration for second subset of the set of multiple resource sets configured for the second UE.

In some examples, the sequence generating component 1560 may be configured as or otherwise support a means for generating a sequence for the CSI-RS based on a first identifier for the first UE, a second identifier for the second UE, or both.

In some examples, the resource configuration component 1565 may be configured as or otherwise support a means for receiving, from a network entity, a configuration of the resource pool associated with the CSI-RS measurement, the resource pool including the set of multiple resource sets.

In some examples, a frequency domain allocation for the CSI-RS resource set spans a total resource pool associated with the sidelink channel.

In some examples, the resource configuration component 1565 may be configured as or otherwise support a means for transmitting, via sidelink control information or sidelink RRC, an indication that a frequency domain allocation for the CSI-RS resource set spans a subset of subchannels of the resource pool associated with the CSI-RS measurement.

In some examples, the resource configuration component 1565 may be configured as or otherwise support a means for transmitting, via sidelink control information, an indication of a time domain allocation for the CSI-RS resource set.

Additionally or alternatively, the communications manager 1520 may support wireless communication at a first UE in accordance with examples as disclosed herein. The trigger signal generating component 1535 may be configured as or otherwise support a means for generating a signal to trigger a CSI report configuration for a sidelink channel. The trigger signal transmitting component 1540 may be configured as or otherwise support a means for transmitting, to a second UE, the signal on a sidelink channel to trigger the CSI report configuration for the sidelink channel, where the signal excludes a grant for data transmission. The resource set determining component 1530 may be configured as or otherwise support a means for transmitting or receiving a CSI-RS based on the CSI report configuration.

In some examples, to support transmitting the signal, the triggering sequence component 1570 may be configured as or otherwise support a means for transmitting a sequence from a set of sequences, via a sequence resource determined from a set of sequence resources, where the sequence and the determined sequence resource indicate the first UE and second UE, and the triggered CSI report configuration.

In some examples, the triggering sequence component 1570 may be configured as or otherwise support a means for determining the sequence resource based on a source-destination identifier.

In some examples, the triggering sequence component 1570 may be configured as or otherwise support a means for determining the sequence based on one or more of the triggered CSI report configuration and a CSI-RS resource configuration.

In some examples, the triggering sequence component 1570 may be configured as or otherwise support a means for determining the sequence resource based on a destination identifier for the CSI report configuration.

In some examples, the triggering sequence component 1570 may be configured as or otherwise support a means for determining the sequence based on a source identifier and one or more of the triggered CSI report configuration and a CSI-RS resource configuration.

In some examples, to support transmitting the signal, the triggering sequence component 1570 may be configured as or otherwise support a means for transmitting the signal in the sequence resource selected from a set of multiple available sequence resources, where the set of multiple available sequence resources is configured at the first UE via system information, Radio Resource Control (RRC) signaling from a base station, or sidelink RRC signaling with the second UE.

In some examples, to support transmitting the signal, the triggering SCI component 1575 may be configured as or otherwise support a means for transmitting a sidelink control information (SCI) message including a CSI request excluding the grant for data transmission.

In some examples, the SCI message has a first format of a first-stage SCI message without data, has a second format of the first-stage SCI message, or is a second-stage SCI message.

In some examples, the triggering SCI component 1575 may be configured as or otherwise support a means for scrambling an CRC of the SCI message based on the SCI message having the first format of the first-stage SCI message.

In some examples, the SCI message includes one or more of a time domain resource allocation field of a CSI-RS, a frequency domain resource allocation field of the CSI-RS, and a PSFCH resource indicator.

In some examples, a physical sidelink feedback channel (PSFCH) for reporting a CSI-RS measurement is a long PSFCH spanning multiple symbol periods. In some examples, the PSFCH is indicated in a sidelink control information (SCI) message to trigger the CSI report configuration, or the PSFCH is indicated based at last in part on one or more of a sequence resource, a sequence transmitted on the sequence resource, and a slot index of the sequence resource, or the PSFCH is indicated based at last in part on one or more of a source-destination identifier, a triggered CSI report identifier, and a slot index of a sequence transmission occasion.

In some examples, the resource selection component 1580 may be configured as or otherwise support a means for determining a set of resources within a selection window based on a spectral efficiency or a CQI for the set of candidate CSI-RS resources satisfying a first spectral efficiency threshold or a first CQI threshold.

In some examples, the resource selection component 1580 may be configured as or otherwise support a means for determining a proportion of the set of resources does not satisfy a threshold. In some examples, the resource selection component 1580 may be configured as or otherwise support a means for determining a second spectral efficiency threshold which is lower than the first spectral efficiency threshold, or a second CQI threshold which is lower than the first CQI threshold, or any combination thereof. In some examples, the resource selection component 1580 may be configured as or otherwise support a means for determining a second set of candidate resources based on the second spectral efficiency threshold or the second CQI threshold, or both.

Additionally or alternatively, the communications manager 1520 may support wireless communication at a second UE in accordance with examples as disclosed herein. The trigger message receiving component 1545 may be configured as or otherwise support a means for receiving, from a first UE, a trigger message on a sidelink channel to trigger a CSI report. In some examples, the resource set determining component 1530 may be configured as or otherwise support a means for determining, from a set of multiple resource sets within a CSI-RS resource or a resource set pool, a CSI-RS resource set used for CSI measurement based on channel sensing or based on a first identifier of the first UE, or a second identifier of the second UE, or a CSI report configuration identifier, or any combination thereof.

Additionally or alternatively, the communications manager 1520 may support wireless communication at a second UE in accordance with examples as disclosed herein. The trigger signal receiving component 1550 may be configured as or otherwise support a means for receiving, from a first UE, a signal on a sidelink channel to trigger a CSI report configuration for a sidelink channel, where the signal excludes a grant for data transmission. In some examples, the trigger signal receiving component 1550 may be configured as or otherwise support a means for determining a destination identifier for a CSI measurement and a source identifier for the CSI measurement based on the signal.

FIG. 16 shows a diagram of a system 1600 including a device 1605 that supports sidelink channel state information reference signal triggering and resource selection in accordance with aspects of the present disclosure. The device 1605 may be an example of or include the components of a device 1305, a device 1405, or a UE 115 as described herein. The device 1605 may communicate wirelessly with one or more base stations 105, UEs 115, or any combination thereof. The device 1605 may include components for bi-directional voice and data communications including components for transmitting and receiving communications, such as a communications manager 1620, an input/output (I/O) controller 1610, a transceiver 1615, an antenna 1625, a memory 1630, code 1635, and a processor 1640. These components may be in electronic communication or otherwise coupled (e.g., operatively, communicatively, functionally, electronically, electrically) via one or more buses (e.g., a bus 1645).

The I/O controller 1610 may manage input and output signals for the device 1605. The I/O controller 1610 may also manage peripherals not integrated into the device 1605. In some cases, the I/O controller 1610 may represent a physical connection or port to an external peripheral. In some cases, the I/O controller 1610 may utilize an operating system such as iOS®, ANDROID®, MS-DOS®, MS-WINDOWS®, OS/2®, UNIX®, LINUX®, or another known operating system. Additionally or alternatively, the I/O controller 1610 may represent or interact with a modem, a keyboard, a mouse, a touchscreen, or a similar device. In some cases, the I/O controller 1610 may be implemented as part of a processor, such as the processor 1640. In some cases, a user may interact with the device 1605 via the I/O controller 1610 or via hardware components controlled by the I/O controller 1610.

In some cases, the device 1605 may include a single antenna 1625. However, in some other cases, the device 1605 may have more than one antenna 1625, which may be capable of concurrently transmitting or receiving multiple wireless transmissions. The transceiver 1615 may communicate bi-directionally, via the one or more antennas 1625, wired, or wireless links as described herein. For example, the transceiver 1615 may represent a wireless transceiver and may communicate bi-directionally with another wireless transceiver. The transceiver 1615 may also include a modem to modulate the packets, to provide the modulated packets to one or more antennas 1625 for transmission, and to demodulate packets received from the one or more antennas 1625. The transceiver 1615, or the transceiver 1615 and one or more antennas 1625, may be an example of a transmitter 1315, a transmitter 1415, a receiver 1310, a receiver 1410, or any combination thereof or component thereof, as described herein.

The memory 1630 may include random access memory (RAM) and read-only memory (ROM). The memory 1630 may store computer-readable, computer-executable code 1635 including instructions that, when executed by the processor 1640, cause the device 1605 to perform various functions described herein. The code 1635 may be stored in a non-transitory computer-readable medium such as system memory or another type of memory. In some cases, the code 1635 may not be directly executable by the processor 1640 but may cause a computer (e.g., when compiled and executed) to perform functions described herein. In some cases, the memory 1630 may contain, among other things, a basic I/O system (BIOS) which may control basic hardware or software operation such as the interaction with peripheral components or devices.

The processor 1640 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1640 may be configured to operate a memory array using a memory controller. In some other cases, a memory controller may be integrated into the processor 1640. The processor 1640 may be configured to execute computer-readable instructions stored in a memory (e.g., the memory 1630) to cause the device 1605 to perform various functions (e.g., functions or tasks supporting sidelink channel state information reference signal triggering and resource selection). For example, the device 1605 or a component of the device 1605 may include a processor 1640 and memory 1630 coupled to the processor 1640, the processor 1640 and memory 1630 configured to perform various functions described herein.

The communications manager 1620 may support wireless communication at a first UE in accordance with examples as disclosed herein. For example, the communications manager 1620 may be configured as or otherwise support a means for transmitting, to a second UE, a trigger message on a sidelink channel to trigger a CSI report. The communications manager 1620 may be configured as or otherwise support a means for determining, from a set of multiple resource sets within a CSI-RS resource or a resource set pool, a CSI-RS resource set used for CSI measurement based on performing channel sensing or based on a first identifier of the first UE, or a second identifier of the second UE, or a CSI report configuration identifier, or any combination thereof. The communications manager 1620 may be configured as or otherwise support a means for transmitting or receiving a CSI-RS in the determined CSI-RS resource set.

Additionally or alternatively, the communications manager 1620 may support wireless communication at a first UE in accordance with examples as disclosed herein. For example, the communications manager 1620 may be configured as or otherwise support a means for generating a signal to trigger a CSI report configuration for a sidelink channel. The communications manager 1620 may be configured as or otherwise support a means for transmitting, to a second UE, the signal on a sidelink channel to trigger the CSI report configuration for the sidelink channel, where the signal excludes a grant for data transmission. The communications manager 1620 may be configured as or otherwise support a means for transmitting or receiving a CSI-RS based on the CSI report configuration.

Additionally or alternatively, the communications manager 1620 may support wireless communication at a second UE in accordance with examples as disclosed herein. For example, the communications manager 1620 may be configured as or otherwise support a means for receiving, from a first UE, a trigger message on a sidelink channel to trigger a CSI report. The communications manager 1620 may be configured as or otherwise support a means for determining, from a set of multiple resource sets within a CSI-RS resource or a resource set pool, a CSI-RS resource set used for CSI measurement based on channel sensing or based on a first identifier of the first UE, or a second identifier of the second UE, or a CSI report configuration identifier, or any combination thereof. The communications manager 1620 may be configured as or otherwise support a means for transmitting or receiving a CSI-RS in the determined CSI-RS resource set.

Additionally or alternatively, the communications manager 1620 may support wireless communication at a second UE in accordance with examples as disclosed herein. For example, the communications manager 1620 may be configured as or otherwise support a means for receiving, from a first UE, a signal on a sidelink channel to trigger a CSI report configuration for a sidelink channel, where the signal excludes a grant for data transmission. The communications manager 1620 may be configured as or otherwise support a means for determining a destination identifier for a CSI measurement and a source identifier for the CSI measurement based on the signal. The communications manager 1620 may be configured as or otherwise support a means for transmitting or receiving a CSI-RS based on the CSI report configuration.

By including or configuring the communications manager 1620 in accordance with examples as described herein, the device 1605 may support techniques for performing sidelink CSI prior to a sidelink data transmission. Additionally, these techniques may be used to perform sidelink CSI on subchannels which are used for sidelink data transmission. Additionally, some techniques may prevent CSI-RS resource collision.

In some examples, the communications manager 1620 may be configured to perform various operations (e.g., receiving, monitoring, transmitting) using or otherwise in cooperation with the transceiver 1615, the one or more antennas 1625, or any combination thereof. Although the communications manager 1620 is illustrated as a separate component, in some examples, one or more functions described with reference to the communications manager 1620 may be supported by or performed by the processor 1640, the memory 1630, the code 1635, or any combination thereof. For example, the code 1635 may include instructions executable by the processor 1640 to cause the device 1605 to perform various aspects of sidelink channel state information reference signal triggering and resource selection as described herein, or the processor 1640 and the memory 1630 may be otherwise configured to perform or support such operations.

FIG. 17 shows a flowchart illustrating a method 1700 that supports sidelink channel state information reference signal triggering and resource selection in accordance with aspects of the present disclosure. The operations of the method 1700 may be implemented by a UE or its components as described herein. For example, the operations of the method 1700 may be performed by a UE 115 as described with reference to FIGS. 1 through 16. In some examples, a UE may execute a set of instructions to control the functional elements of the UE to perform the described functions. Additionally or alternatively, the UE may perform aspects of the described functions using special-purpose hardware.

At 1705, the method may include transmitting, to a second UE, a trigger message on a sidelink channel to trigger a CSI report. The operations of 1705 may be performed in accordance with examples as disclosed herein. In some examples, aspects of the operations of 1705 may be performed by a trigger message transmitting component 1525 as described with reference to FIG. 15.

At 1710, the method may include determining, from a set of multiple resource sets within a CSI reference signal (CSI-RS) resource or a resource set pool, a CSI-RS resource set used for CSI measurement based on performing channel sensing or based on a first identifier of the first UE, or a second identifier of the second UE, or a CSI report configuration identifier, or any combination thereof. The operations of 1710 may be performed in accordance with examples as disclosed herein. In some examples, aspects of the operations of 1710 may be performed by a resource set determining component 1530 as described with reference to FIG. 15.

At 1715, the method may include transmitting or receiving a CSI-RS in the determined CSI-RS resource set. The operations of 1715 may be performed in accordance with examples as disclosed herein. In some examples, aspects of the operations of 1715 may be performed by a resource set determining component 1530 as described with reference to FIG. 15.

FIG. 18 shows a flowchart illustrating a method 1800 that supports sidelink channel state information reference signal triggering and resource selection in accordance with aspects of the present disclosure. The operations of the method 1800 may be implemented by a UE or its components as described herein. For example, the operations of the method 1800 may be performed by a UE 115 as described with reference to FIGS. 1 through 16. In some examples, a UE may execute a set of instructions to control the functional elements of the UE to perform the described functions. Additionally or alternatively, the UE may perform aspects of the described functions using special-purpose hardware.

At 1805, the method may include generating a signal to trigger a CSI report configuration for a sidelink channel. The operations of 1805 may be performed in accordance with examples as disclosed herein. In some examples, aspects of the operations of 1805 may be performed by a trigger signal generating component 1535 as described with reference to FIG. 15.

At 1810, the method may include transmitting, to a second UE, the signal on a sidelink channel to trigger the CSI report configuration for the sidelink channel, where the signal excludes a grant for data transmission. The operations of 1810 may be performed in accordance with examples as disclosed herein. In some examples, aspects of the operations of 1810 may be performed by a trigger signal transmitting component 1540 as described with reference to FIG. 15.

At 1815, the method may include transmitting or receiving a CSI-RS based on the CSI report configuration. The operations of 1815 may be performed in accordance with examples as disclosed herein. In some examples, aspects of the operations of 1815 may be performed by a trigger signal generating component 1530 as described with reference to FIG. 15.

FIG. 19 shows a flowchart illustrating a method 1900 that supports sidelink channel state information reference signal triggering and resource selection in accordance with aspects of the present disclosure. The operations of the method 1900 may be implemented by a UE or its components as described herein. For example, the operations of the method 1900 may be performed by a UE 115 as described with reference to FIGS. 1 through 16. In some examples, a UE may execute a set of instructions to control the functional elements of the UE to perform the described functions. Additionally or alternatively, the UE may perform aspects of the described functions using special-purpose hardware.

At 1905, the method may include receiving, from a first UE, a trigger message on a sidelink channel to trigger a CSI report. The operations of 1905 may be performed in accordance with examples as disclosed herein. In some examples, aspects of the operations of 1905 may be performed by a trigger message receiving component 1545 as described with reference to FIG. 15.

At 1910, the method may include determining, from a set of multiple resource sets within a CSI reference signal (CSI-RS) resource or a resource set pool, a CSI-RS resource set used for CSI measurement based on channel sensing or based on a first identifier of the first UE, or a second identifier of the second UE, or a CSI report configuration identifier, or any combination thereof. The operations of 1910 may be performed in accordance with examples as disclosed herein. In some examples, aspects of the operations of 1910 may be performed by a resource set determining component 1530 as described with reference to FIG. 15.

At 1915, the method may include transmitting or receiving a CSI-RS in the determined CSI-RS resource set. The operations of 1915 may be performed in accordance with examples as disclosed herein. In some examples, aspects of the operations of 1915 may be performed by a resource set determining component 1530 as described with reference to FIG. 15.

FIG. 20 shows a flowchart illustrating a method 2000 that supports sidelink channel state information reference signal triggering and resource selection in accordance with aspects of the present disclosure. The operations of the method 2000 may be implemented by a UE or its components as described herein. For example, the operations of the method 2000 may be performed by a UE 115 as described with reference to FIGS. 1 through 16. In some examples, a UE may execute a set of instructions to control the functional elements of the UE to perform the described functions. Additionally or alternatively, the UE may perform aspects of the described functions using special-purpose hardware.

At 2005, the method may include receiving, from a first UE, a signal on a sidelink channel to trigger a CSI report configuration for a sidelink channel, where the signal excludes a grant for data transmission. The operations of 2005 may be performed in accordance with examples as disclosed herein. In some examples, aspects of the operations of 2005 may be performed by a trigger signal receiving component 1550 as described with reference to FIG. 15.

At 2010, the method may include determining a destination identifier for a CSI measurement and a source identifier for the CSI measurement based on the signal. The operations of 2010 may be performed in accordance with examples as disclosed herein. In some examples, aspects of the operations of 2010 may be performed by a trigger signal receiving component 1550 as described with reference to FIG. 15.

At 2005, the method may include transmitting or receiving a CSI-RS based at on the CSI report configuration. The operations of 2005 may be performed in accordance with examples as disclosed herein. In some examples, aspects of the operations of 2005 may be performed by a resource set determining component 1530 as described with reference to FIG. 15.

The following provides an overview of aspects of the present disclosure:

Aspect 1: A method for wireless communication at a first UE, comprising: transmitting, to a second UE, a trigger message on a sidelink channel to trigger a CSI report; determining, from a plurality of resource sets within a CSI reference signal (CSI-RS) resource or a resource set pool, a CSI-RS resource set used for CSI measurement based on performing channel sensing or based on a first identifier of the first UE or a second identifier of the second UE, or a CSI report configuration identifier, or any combination thereof; and transmitting or receiving a CSI-RS in the determined CSI-RS resource set.

Aspect 2: The method of aspect 1, wherein determining the CSI-RS resource set comprises: transmitting a signaling to indicate the CSI-RS resource set based at least in part on performing channel sensing on the plurality of resource sets within the CSI-RS resource or the resource set pool.

Aspect 3: The method of any of aspects 1 through 2, wherein determining the CSI-RS resource set comprises: determining the CSI-RS resource set based on ID of first UE, ID of the second UE or both.

Aspect 4: The method of aspect 1, wherein determining the CSI-RS resource set further comprises: determining a subset of CSI-RS resource sets from the resource set pool; and transmitting a signaling to indicate the CSI-RS resource set based at least in part on performing channel sensing on the plurality of resource sets within the subset.

Aspect 5: The method of aspect 4, further comprising: determining the subset of CSI-RS resource sets from the resource set pool based at least in part on one or more of the first identifier of the first UE or the second identifier of the second UE, or both, a resource configuration or resource set configuration exchanged with the second UE via sidelink Radio Resource Control signaling, or an association between the CSI report and the subset of the plurality of resource sets.

Aspect 6: The method of aspect 1, wherein transmitting the trigger message comprises: determining an association between a plurality of CSI report configurations and the plurality of resource sets; and determining, based on the association, the CSI-RS resource set according to a CSI report configuration for the triggered CSI report.

Aspect 7: The method of aspect 6, further comprising: transmitting, to the second UE via sidelink Radio Resource Control (RRC) signaling, an indication of the association between the CSI-RS resource set and the CSI report configuration, used by first UE.

Aspect 8: The method of any of aspects 6 through 7, further comprising: receiving, from the second UE via sidelink Radio Resource Control (RRC) signaling, an indication of the association between the CSI-RS resource set and the CSI report configuration, used by the second UE.

Aspect 9: The method of any of aspects 1 through 8, further comprising: exchanging, with the second UE via sidelink Radio Resource Control (RRC) signaling, a first configuration for a first subset of the plurality of resource sets configured for the first UE and a second configuration for second subset of the plurality of resource sets configured for the second UE.

Aspect 10: The method of any of aspects 1 through 9, further comprising: generating a sequence for a CSI-RS based at least in part on the first identifier for the first UE, the second identifier for the second UE, or both.

Aspect 11: The method of any of aspects 1 through 10, further comprising: receiving, from a network entity, a configuration of the resource set pool associated with CSI-RS measurement, the resource set pool comprising the plurality of resource sets.

Aspect 12: The method of aspect 11, wherein a frequency domain allocation for the CSI-RS resource set spans a total resource pool associated with the sidelink channel.

Aspect 13: The method of any of aspects 11 through 12, further comprising: transmitting, via sidelink control information or sidelink Radio Resource Control (RRC), an indication that a frequency domain allocation for the CSI-RS resource set spans a subset of subchannels of a resource pool associated with the sidelink channel.

Aspect 14: The method of any of aspects 11 through 13, further comprising: transmitting, via sidelink control information, an indication of a time domain allocation for the CSI-RS resource set.

Aspect 15: A method for wireless communication at a first UE, comprising: generating a signal to trigger a CSI report configuration for a sidelink channel; transmitting, to a second UE, the signal on the sidelink channel to trigger the CSI report configuration for the sidelink channel, wherein the signal excludes a grant for data transmission; and transmitting or receiving a CSI-RS based at least in part on the CSI report configuration.

Aspect 16: The method of aspect 15, wherein transmitting the signal comprises: transmitting a sequence from a set of sequences, via a sequence resource determined from a set of sequence resources, wherein the sequence and the determined sequence resource indicate the first UE, the second UE and the triggered CSI report configuration.

Aspect 17: The method of aspect 16, further comprising: determining the sequence resource based at least in part on a source-destination identifier.

Aspect 18: The method of aspect 17, further comprising: determining the sequence based at least in part on one or more of the triggered CSI report configuration and a CSI reference signal (CSI-RS) resource configuration.

Aspect 19: The method of any of aspects 16 through 18, further comprising: determining the sequence resource based at least in part on a destination identifier for the CSI report configuration.

Aspect 20: The method of aspect 19, further comprising: determining the sequence based at least in part on a source identifier and one or more of the triggered CSI report configuration and a CSI reference signal (CSI-RS) resource configuration.

Aspect 21: The method of any of aspects 16 through 20, wherein transmitting the signal comprises: transmitting the signal in the sequence resource selected from a plurality of available sequence resources, wherein the plurality of available sequence resources is configured at the first UE via system information, Radio Resource Control (RRC) signaling from a base station, or sidelink RRC signaling with the second UE.

Aspect 22: The method of aspect 15, wherein transmitting the signal comprises: transmitting a sidelink control information (SCI) message comprising a CSI request excluding the grant for data transmission.

Aspect 23: The method of aspect 22, wherein the SCI message has a first format of a first-stage SCI message without data, has a second format of the first-stage SCI message, or is a second-stage SCI message.

Aspect 24: The method of aspect 23, further comprising: scrambling an CRC of the SCI message based at least in part on the SCI message having the first format of the first-stage SCI message.

Aspect 25: The method of any of aspects 22 through 24, wherein the SCI message includes one or more of a time domain resource allocation field of a CSI reference signal (CSI-RS), a frequency domain resource allocation field of the CSI-RS, and a physical sidelink feedback channel (PSFCH) resource indicator.

Aspect 26: The method of any of aspects 15 through 25, wherein a physical sidelink feedback channel (PSFCH) for reporting a CSI-RS measurement is a long PSFCH spanning multiple symbol periods, the PSFCH is indicated in a sidelink control information (SCI) message to trigger the CSI report configuration, or the PSFCH is indicated based at last in part on one or more of a sequence resource, a sequence transmitted on the sequence resource, and a slot index of the sequence resource, or the PSFCH is indicated based at last in part on one or more of a source-destination identifier, a triggered CSI report identifier, and a slot index of a sequence transmission occasion.

Aspect 27: The method of any of aspects 15 through 26, further comprising: determining a set of resources within a selection window based at least in part on a spectral efficiency or a channel quality indicator (CQI) for the set of candidate CSI-RS resources satisfying a first spectral efficiency threshold or a first CQI threshold.

Aspect 28: The method of aspect 27, further comprising: determining a proportion of the set of resources does not satisfy a threshold; and determining a second spectral efficiency threshold which is lower than the first spectral efficiency threshold, or a second CQI threshold which is lower than the first CQI threshold, or any combination thereof; and determining a second set of candidate resources based at least in part on the second spectral efficiency threshold or the second CQI threshold.

Aspect 29: A method for wireless communication at a second UE, comprising: receiving, from a first UE, a trigger message on a sidelink channel to trigger a CSI report; determining, from a plurality of resource sets within a CSI reference signal (CSI-RS) resource or a resource set pool, a CSI-RS resource set used for CSI measurement based on channel sensing or based on a first identifier of the first UE, or a second identifier of the second UE, or a CSI report configuration identifier, or any combination thereof; and transmitting or receiving a CSI-RS in the determined CSI-RS resource set.

Aspect 30: A method for wireless communication at a second UE, comprising: receiving, from a first UE, a signal on a sidelink channel to trigger a CSI report configuration for the sidelink channel, wherein the signal excludes a grant for data transmission; determining a destination identifier for a CSI measurement and a source identifier for the CSI measurement based at least in part on the signal; and transmitting or receiving a CSI-RS based at least in part on the CSI report configuration.

Aspect 31: An apparatus for wireless communication at a first UE, comprising a processor; memory coupled with the processor; and instructions stored in the memory and executable by the processor to cause the apparatus to perform a method of any of aspects 1 through 14.

Aspect 32: An apparatus for wireless communication at a first UE, comprising at least one means for performing a method of any of aspects 1 through 14.

Aspect 33: A non-transitory computer-readable medium storing code for wireless communication at a first UE, the code comprising instructions executable by a processor to perform a method of any of aspects 1 through 14.

Aspect 34: An apparatus for wireless communication at a first UE, comprising a processor; memory coupled with the processor; and instructions stored in the memory and executable by the processor to cause the apparatus to perform a method of any of aspects 15 through 28.

Aspect 35: An apparatus for wireless communication at a first UE, comprising at least one means for performing a method of any of aspects 15 through 28.

Aspect 36: A non-transitory computer-readable medium storing code for wireless communication at a first UE, the code comprising instructions executable by a processor to perform a method of any of aspects 15 through 28.

Aspect 37: An apparatus for wireless communication at a second UE, comprising a processor; memory coupled with the processor; and instructions stored in the memory and executable by the processor to cause the apparatus to perform a method of any of aspects 29 through 29.

Aspect 38: An apparatus for wireless communication at a second UE, comprising at least one means for performing a method of any of aspects 29 through 29.

Aspect 39: A non-transitory computer-readable medium storing code for wireless communication at a second UE, the code comprising instructions executable by a processor to perform a method of any of aspects 29 through 29.

Aspect 40: An apparatus for wireless communication at a second UE, comprising a processor; memory coupled with the processor; and instructions stored in the memory and executable by the processor to cause the apparatus to perform a method of any of aspects 30 through 30.

Aspect 41: An apparatus for wireless communication at a second UE, comprising at least one means for performing a method of any of aspects 30 through 30.

Aspect 42: A non-transitory computer-readable medium storing code for wireless communication at a second UE, the code comprising instructions executable by a processor to perform a method of any of aspects 30 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a first user equipment (UE), comprising:
a processor;
memory coupled with the processor; and
instructions stored in the memory and executable by the processor to cause the apparatus to:
transmit, to a second UE, a trigger message on a sidelink channel to trigger a channel state information (CSI) report; and
determine, from a plurality of resource sets within a CSI reference signal (CSI-RS) resource or a resource set pool, a CSI-RS resource set used for CSI measurement based on performing channel sensing or based on a first identifier of the first UE or a second identifier of the second UE, or a CSI report configuration identifier, or any combination thereof; and
transmit or receive a CSI-RS in the determined CSI-RS resource set.

2. The apparatus of claim 1, wherein the instructions to determine the CSI-RS resource set are executable by the processor to cause the apparatus to:
transmit a signaling to indicate the CSI-RS resource set based at least in part on performing channel sensing on the plurality of resource sets within the CSI-RS resource or the resource set pool.

3. The apparatus of claim 1, wherein the instructions to determine the CSI-RS resource set are executable by the processor to cause the apparatus to:
determine the CSI-RS resource set based on ID of first UE, ID of the second UE or both.

4. The apparatus of claim 1, wherein the instructions to determine the CSI-RS resource set are further executable by the processor to cause the apparatus to:
determine a subset of CSI-RS resource sets from the resource set pool; and
transmit a signaling to indicate the CSI-RS resource set based at least in part on performing channel sensing on the plurality of resource sets within the subset.

5. The apparatus of claim 4, wherein the instructions are further executable by the processor to cause the apparatus to:
determine the subset of CSI-RS resource sets from the resource set pool based at least in part on one or more of the first identifier of the first UE or the second identifier of the second UE, or both, a resource configuration or resource set configuration exchanged with the second UE via sidelink Radio Resource Control signaling, or an association between the CSI report and the subset of the plurality of resource sets.

6. The apparatus of claim 1, wherein the instructions to transmit the trigger message are executable by the processor to cause the apparatus to:
determine an association between a plurality of CSI report configurations and the plurality of resource sets; and
determine, based on the association, the CSI-RS resource set according to a CSI report configuration for the triggered CSI report.

7. The apparatus of claim 6, wherein the instructions are further executable by the processor to cause the apparatus to:
transmit, to the second UE via sidelink Radio Resource Control (RRC) signaling, an indication of the association between the CSI-RS resource set and the CSI report configuration, used by first UE.

8. The apparatus of claim 6, wherein the instructions are further executable by the processor to cause the apparatus to:
receive, from the second UE via sidelink Radio Resource Control (RRC) signaling, an indication of the association between the CSI-RS resource set and the CSI report configuration, used by the second UE.

9. The apparatus of claim 1, wherein the instructions are further executable by the processor to cause the apparatus to:
exchange, with the second UE via sidelink Radio Resource Control (RRC) signaling, a first configuration for a first subset of the plurality of resource sets configured for the first UE and a second configuration for second subset of the plurality of resource sets configured for the second UE.

10. The apparatus of claim 1, wherein the instructions are further executable by the processor to cause the apparatus to:
generate a sequence for the CSI-RS based at least in part on the first identifier for the first UE, the second identifier for the second UE, or both.

11. The apparatus of claim 1, wherein the instructions are further executable by the processor to cause the apparatus to:
receive, from a network entity, a configuration of the resource set pool associated with CSI-RS measurement, the resource set pool comprising the plurality of resource sets.

12. The apparatus of claim 11, wherein a frequency domain allocation for the CSI-RS resource set spans a total resource pool associated with the sidelink channel.

13. The apparatus of claim 11, wherein the instructions are further executable by the processor to cause the apparatus to:
transmit, via sidelink control information or sidelink Radio Resource Control (RRC), an indication that a frequency domain allocation for the CSI-RS resource set spans a subset of subchannels of a resource pool associated with the sidelink channel.

14. The apparatus of claim 11, wherein the instructions are further executable by the processor to cause the apparatus to:
transmit, via sidelink control information, an indication of a time domain allocation for the CSI-RS resource set.

15. An apparatus for wireless communication at a first user equipment (UE), comprising:
a processor;
memory coupled with the processor; and
instructions stored in the memory and executable by the processor to cause the apparatus to:
generate a signal to trigger a channel state information (CSI) report configuration for a sidelink channel;
transmit, to a second UE, the signal on the sidelink channel to trigger the CSI report configuration for the sidelink channel, wherein the signal excludes a grant for data transmission; and
transmit or receive a CSI-RS based at least in part on the CSI report configuration.

16. The apparatus of claim 15, wherein the instructions to transmit the signal are executable by the processor to cause the apparatus to:
transmit a sequence from a set of sequences, via a sequence resource determined from a set of sequence resources, wherein the sequence and the determined sequence resource indicate the first UE, the second UE and the triggered CSI report configuration.

17. The apparatus of claim 16, wherein the instructions are further executable by the processor to cause the apparatus to:
determine the sequence resource based at least in part on a source-destination identifier.

18. The apparatus of claim 17, wherein the instructions are further executable by the processor to cause the apparatus to:
determine the sequence based at least in part on one or more of the triggered CSI report configuration and a CSI reference signal (CSI-RS) resource configuration.

19. The apparatus of claim 16, wherein the instructions are further executable by the processor to cause the apparatus to:
determine the sequence resource based at least in part on a destination identifier for the CSI report configuration.

20. The apparatus of claim 19, wherein the instructions are further executable by the processor to cause the apparatus to:
determine the sequence based at least in part on a source identifier and one or more of the triggered CSI report configuration and a CSI reference signal (CSI-RS) resource configuration.

21. The apparatus of claim 16, wherein the instructions to transmit the signal are executable by the processor to cause the apparatus to:
transmit the signal in the sequence resource selected from a plurality of available sequence resources, wherein the plurality of available sequence resources is configured at the first UE via system information, Radio Resource Control (RRC) signaling from a base station, or sidelink RRC signaling with the second UE.

22. The apparatus of claim 15, wherein the instructions to transmit the signal are executable by the processor to cause the apparatus to:
transmit a sidelink control information (SCI) message comprising a CSI request excluding the grant for data transmission.

23. The apparatus of claim 22, wherein the SCI message has a first format of a first-stage SCI message without data, has a second format of the first-stage SCI message, or is a second-stage SCI message.

24. The apparatus of claim 23, wherein the instructions are further executable by the processor to cause the apparatus to:
scramble a cyclic redundancy check (CRC) of the SCI message based at least in part on the SCI message having the first format of the first-stage SCI message.

25. The apparatus of claim 22, wherein the SCI message includes one or more of a time domain resource allocation field of a CSI reference signal (CSI-RS), a frequency domain resource allocation field of the CSI-RS, and a physical sidelink feedback channel (PSFCH) resource indicator.

26. The apparatus of claim 15, wherein a physical sidelink feedback channel (PSFCH) for reporting a CSI-RS measurement is a long PSFCH spanning multiple symbol periods, the PSFCH is indicated in a sidelink control information (SCI) message to trigger the CSI report configuration, or the PSFCH is indicated based at last in part on one or more of a sequence resource, a sequence transmitted on the sequence resource, and a slot index of the sequence resource, or the PSFCH is indicated based at last in part on one or more of a source-destination identifier, a triggered CSI report identifier, and a slot index of a sequence transmission occasion.

27. The apparatus of claim 15, wherein the instructions are further executable by the processor to cause the apparatus to:
determine a set of resources within a selection window based at least in part on a spectral efficiency or a channel quality indicator (CQI) for the set of candidate CSI-RS resources satisfying a first spectral efficiency threshold or a first CQI threshold.

28. The apparatus of claim 27, wherein the instructions are further executable by the processor to cause the apparatus to:
determine a proportion of the set of resources does not satisfy a threshold; and
determine a second spectral efficiency threshold which is lower than the first spectral efficiency threshold, or a second CQI threshold which is lower than the first CQI threshold, or any combination thereof; and
determine a second set of candidate resources based at least in part on the second spectral efficiency threshold or the second CQI threshold.

29. An apparatus for wireless communication at a second user equipment (UE), comprising:
a processor;
memory coupled with the processor; and
instructions stored in the memory and executable by the processor to cause the apparatus to:
receive, from a first UE, a trigger message on a sidelink channel to trigger a channel state information (CSI) report;
determine, from a plurality of resource sets within a CSI reference signal (CSI-RS) resource or a resource set pool, a CSI-RS resource set used for CSI measurement based on channel sensing or based on a first identifier of the first UE, or a second identifier of the second UE, or a CSI report configuration identifier, or any combination thereof; and
transmit or receive a CSI-RS in the determined CSI-RS resource set.

30. An apparatus for wireless communication at a second user equipment (UE), comprising:
a processor;
memory coupled with the processor; and
instructions stored in the memory and executable by the processor to cause the apparatus to:
receive, from a first UE, a signal on a sidelink channel to trigger a channel state information (CSI) report configuration for the sidelink channel, wherein the signal excludes a grant for data transmission;
determine a destination identifier for a CSI measurement and a source identifier for the CSI measurement based at least in part on the signal; and
transmit or receive a CSI-RS based at least in part on the CSI report configuration.
